(19) United States
(12) Patent Application Publication
(10) Pub. No.: US 2017/0139894 A1
(43) Pub. Date: May 18, 2017

(54) METHOD AND SYSTEM FOR DYNAMIC DATA MODELING FOR USE IN REAL-TIME COMPUTERIZED PRESENTATIONS

(71) Applicant: WELCH GLOBAL CONSULTING, INC., Colorado Springs, CO (US)

(72) Inventor: Michael Wayne Welch, Colorado Springs, CO (US)

(21) Appl. No.: 15/361,204

(22) Filed: Nov. 25, 2016

Related U.S. Application Data
(63) Continuation-in-part of application No. 13/819,257, filed on Feb. 26, 2013.
(60) Provisional application No. 61/384,531, filed on Sep. 20, 2010.

(51) Int. Cl. G06F 17/24; G06T 11/20; G06F 17/50

(52) U.S. Cl. CPC G06F 17/246; G06F 17/5009; G06T 11/206; G06F 17/243; G06F 2217/16

(57) ABSTRACT

A system and related method for dynamic data modeling for use in a real-time computerized presentation system includes a presentation engine having a visual interface. Computerized numerical models are each importable into the presentation engine. Each includes a data grid having data cells arranged by columns and rows, where numerical data values are stored within the data cells. At least one data input field controls a manipulation of a first numerical data value in a first data cell using a mathematical function applied to a second numerical data value in a second data cell. A numerical model display, displayable on the visual interface, is based on the first numerical data value and is changed in real-time based on the manipulation of the first numerical data value. A numerical model summary, displayable on the visual interface, combines numerical data from the computerized models imported into the presentation engine.

### CROSS REFERENCE TO RELATED APPLICATION

This application is a continuation-in-part, and claims benefit, of U.S. patent application Ser. No. 13/819,257 filed Feb. 26, 2013, which is a National Stage Entry of PCT/US2011/052410 filed Sep. 20, 2011, which claims the benefit of U.S. Provisional Application Serial No. 61/384,531 filed Sep. 20, 2010, the entire disclosures of which are incorporated herein by reference.

### FIELD

The present disclosure is generally related to computerized data modeling and more particularly is related to methods and systems for dynamic data modeling for use in real-time computerized presentations.

### BACKGROUND

The success of many commercial enterprises depends on the ability to sell their products, whatever they are. Some commercial enterprises predominately sell consumer goods through well-known retail channels including physical stores and through web sites over the Internet. To effect sales, potential purchasers are enticed to learn about the products by seeing them and/or through advertising. However, not all commercial enterprises are capable of selling their products in this way. Many companies manufacture products intended to be purchased by other companies, not individual consumers, and thus these companies cannot simply sell their products within retail establishments. These products, which may be referred to as corporate products are sold by business-to-business (B2B) sales people, and can vary greatly, but they generally include large scale items with a high cost, such as industrial machinery, manufacturing equipment, and software products, which are sold to a prospective purchasing company by a sales person or a sales team.

The processing for selling a corporate product to a company has changed little over the recent decades. Generally, to effect sales of the corporate product, a sales person or sales team from a corporate product seller meets with a representative of a prospective purchasing company. The sales team may be expected to go through a series of steps or actions to demonstrate the corporate product and its benefits and prove to the prospective purchaser that the purchaser's company should purchase the corporate product. This process may include obtaining information from the prospective purchaser about the business of the company and proving to the prospective purchaser that the corporate product being offered for sale is beneficial for the company to purchase based on what is known to the corporate product seller and even after any adjustments made due to the additional information obtained from the prospective purchaser during or after initial demonstrations or presentations. Then, the prospective purchaser makes a decision on whether or not to make the purchase.

In today's business environment, software products are important tools that must be selected carefully and with a full understanding of the impact of the software products on the business of the company. Software has become a foundation of many essential functions of many businesses. For example, software is frequently integral is handling a company's accounting, communications, and customer management. Use of the software products can help a company achieve operation at the most efficient possible level. In some cases, software can be used to improve efficiency even just a fraction of a point, which in turn can equate to a large monetary savings over the course of a year. As an example, companies which receive customer phone calls use software to help the customer representatives manage the phone calls to increase the efficiency of handling the phone calls.

The beneficial impact of large product purchases to the profit of a company often is not evident until after the purchase, so it can be difficult to convince a company to initially invest in a new, costly product such as a new software product. Commonly, a company (e.g., corporations, limited liability companies, partnerships, or any other form of business organization or even sole proprietorship) wants to know the financial value that a new product such as a software product will have to the company prior to purchasing it. If a new product such as a software product will cost $300,000 in a year, the company wants to know that the investment for the software product will be offset by increased revenues or decreased costs within a given time period. Answering these questions of a prospective purchasing company can require significant effort by the salesperson prior to meeting with the prospective purchasing company. For example, the salesperson may need to define how each product and/or product feature makes or saves money for the prospective purchasing company. In order to calculate the financial impact, the calculations for each product must be derived. Each calculation requires data input, so the data requirements for each product must be understood. This information is often assembled or collected and put into in a data spreadsheet.

Using the data provided by the prospective purchasing company, the seller is then tasked with analyzing the data and creating model examples to show the benefits of the product being proposed by the seller, which often involves the salesperson using multiple spreadsheets. Preparing multiple spreadsheets is a time-consuming process. Each prospective purchasing company has individual business objectives and requirements, so the benefits of the product being offered for sale by the salesperson must be tailored to each specific company. This requires that the spreadsheet be customized or created from scratch each time using new or changed data. Changing the data typically means that most calculations are no longer correct so one must update the calculations and the business case, and it frequently requires the salesperson to go back to the originator of the data to adjust the spreadsheet. This process can take days, weeks or even months.

Intensifying this problem is the fact that during a sales presentation by the salesperson, the prospective purchasing company may want to understand how altering one part of the proposal can influence other portions of the proposal. Using the example above relative to managing customer relations, a prospective purchasing company may ask the salesperson what the financial impact of the software product is over 5 years instead of 1 year, or how the software product financially impacts other business considerations. When this type of question arises, the salesperson can often be left with no choice but to open what is most likely a spreadsheet, adjust the data as necessary, and reload the spreadsheet. More frequently, the salesperson or sales team is unable to present changed data or new data during the sales presentation (i.e., in real-time) because the sales team cannot rework the calculations fast enough. In either event, the result may be a lost or delayed sale due to the inability of the sales person/team to fully answer the purchasing company's questions relative to how the product offered for sale will benefit the company. Furthermore, after a sale is complete, successfully or otherwise, the spreadsheet created by the salesperson/sales team to process the data supplied by the customer is typically archived in case there may be some way to use it as a guide or template for that customer in the future. But it is otherwise not useful.

Thus, a heretofore unaddressed need exists in the industry to address the aforementioned deficiencies and inadequacies.

### SUMMARY OF THE DISCLOSURE

Embodiments of the present disclosure provide a dynamic data modeling system for use in a real-time computerized presentation system. Briefly described, one embodiment of the system includes a presentation engine having a visual interface displayable on a display screen of a computer or other screens. The computer has a processor and a non-transitory memory. Computerized numerical models are stored in the non-transitory memory, and each of the computerized numerical models is importable into the presentation engine. Each of the computerized numerical models includes a data grid having a plurality of data cells. Each of the plurality of data cells are arranged into columns and rows. Numerical data values for use in the numerical models are stored within at least a portion of the plurality of data cells. At least one data input field controls a manipulation of a first numerical data value in a first data cell using a mathematical function applied to a second numerical data value in a second data cell. Preferably, data in a plurality of data cells is processed in accordance with mathematical formula(s) to generate data for a different or new data values in others data cells in the data grid. A numerical model display is displayed on the visual interface. The numerical model display is based, at least in part, on the first numerical data value from the first data cell. The numerical model display is changed in real-time based on the manipulation of the first numerical data value. A numerical model summary combines the numerical data from each of the plurality of computerized models imported into the presentation engine, wherein the numerical model summary is displayable on the visual interface.

The present disclosure can also describe methods of modeling data for use in a real-time computerized presentation system. The methods are performed by a processor of a computerized device having a non-transitory memory. In this regard, one embodiment of such a method, among others, can be broadly summarized by the following steps: importing a plurality of computerized numerical models stored on the non-transitory memory of the computerized device into a presentation engine, the presentation engine having a visual interface displayable on at least display screen of the computerized device, wherein each of the plurality of computerized numerical models has a data grid having a plurality of data cells, wherein the plurality of data cells are arranged by columns and rows. Numerical data values are stored within at least a portion of the plurality of data cells; and at least one data input field is used to manipulate at least a first numerical data value within at least a first data cell of the data grid using a mathematical function applied to at least a second numerical data value in a second data cell of the data grid. A numerical model display is visually presented on the display screen of the computer (or other screen) before manipulating the first numerical data value and after manipulating the first numerical data value while maintaining visual display of the numerical model display. The numerical model display can be changed in real-time by an operator or user based on the manipulation of the first numerical data value. That is, the numerical data from each of the plurality of computerized models is imported and combined into the presentation engine. A numerical model summary is visually displayed. It has the combined numerical data from each of the plurality of computerized models on the display screen of the computer.

Embodiments of the present disclosure also provide a computer-implemented, dynamic data modeling system for use in a real-time computerized presentation system. Briefly described, one embodiment of the system includes a presentation engine stored on a non-transitory memory of a computerized device having a processor and a display screen. A visual interface of the presentation engine is displayable on the display screen. The processor of the computerized device is configured to import a plurality of computerized numerical models stored in the non-transitory memory of the computerized device into the presentation engine. Each of the plurality of computerized numerical models has a data grid with a plurality of data cells. The plurality of data cells are arranged by columns and rows; and numerical data values are stored within at least a portion of the plurality of data cells. At least one data input field is provided to a user of the computerized device to control a manipulation of a first numerical data value in a first data cell using a mathematical function applied to a second numerical data value in a second data cell. A numerical model is displayed on the visual interface of the presentation engine. The numerical model display is based, at least in part, on the first numerical data value from the first data cell. The numerical model display is changed in real-time based on the manipulation of the first numerical data value. The numerical data from each of the plurality of computerized models imported into the presentation engine is combined into a numerical model summary which is displayable on the visual interface.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagrammatical illustration of computing architecture on which a dynamic data modeling system can be operated, in accordance with an embodiment of the present disclosure;

FIG. 2A is a schematic diagram of a dynamic data modeling system, in accordance with an embodiment of the present disclosure;

FIG. 2B is a schematic diagram of a dynamic data modeling system during presentation mode, in accordance with an embodiment of the present disclosure;

FIG. 3 is a diagrammatical illustration of the presentation engine, in accordance with an embodiment of the present disclosure;

FIGS. 4-6 are diagrammatical illustrations of visual interfaces of the presentation engine, in accordance with an embodiment of the present disclosure;

FIG. 7 is a diagrammatical illustration of one example of creating the presentation engine, in accordance with an embodiment of the present disclosure;

FIG. 8 is a diagrammatical illustration of the data grid, in accordance with an embodiment of the present disclosure;

FIG. 9 is an illustration of the data input fields, in accordance with an embodiment of the present disclosure;

FIG. 10 is an illustration of the numerical model display, in accordance with an embodiment of the present disclosure;

FIG. 11 is an illustration with flow chart of one example of how the model is built, in accordance with an embodiment of the present disclosure;

FIG. 12 is a diagrammatical illustration of block 4.5 of FIG. 11, in accordance with an exemplary embodiment of the present disclosure;

FIG. 13 is a diagrammatical illustration of the system depicting the model summary, in accordance with an embodiment of the present disclosure;

FIG. 14 is a diagrammatical illustration of the system depicting the model summary, in accordance with an embodiment of the present disclosure;

FIG. 15 is a diagrammatical illustration of the system depicting a business case model, in accordance with an embodiment of the present disclosure;

FIG. 16 is a flowchart illustrating a method of modeling data for use in a real-time computerized presentation system, in accordance with an embodiment of the present disclosure;

FIG. 17 is a depiction of the architecture of the entire system in using graphical or functional factors, in accordance with an example of the present disclosure;

FIG. 18 is a depiction of a user interface screen that a user would see and use to interface with a computer executing or using the system, in accordance with an example of the present disclosure;

FIG. 19 is a depiction of the architecture of a model engine used to compute in and present data, in accordance with an example of the present disclosure;

FIG. 20 is a flow chart showing the flow of data in a model engine, in accordance with an example of the present disclosure;

FIG. 21 is a graph of a model engine presenting data of theoretical example involving a telephone sales system, in accordance with an example of the present disclosure;

FIG. 22 is an image of a data input page visible on a user's computer for a theoretical example involving a telephone call system, in accordance with an example of the present disclosure;

FIG. 23 is an image depicting a system administration data input page for creating and editing close rate for a theoretical model interface calculations for a theoretical example involving a telephone call system, in accordance with an example of the present disclosure;

FIG. 24 is a graph of a cash flow model of a theoretical example involving a telephone sales system involving the close rate of sales made by telephone, in accordance with an example of the present disclosure;

FIG. 25 is an image of a data input page for the cash flow model used to select financial models that are summarized in the cash flow model, in accordance with an example of the present disclosure;

FIG. 26 is an image of a business case model visible on a user's computer for a theoretical example involving a telephone call system, in accordance with an example of the present disclosure;

FIG. 27 is an image of the data input page of the business case model used to select cash flow models used in the business case model of FIG. 26, in accordance with an example of the present disclosure;

FIG. 28 is an illustration of a real-time presentation for selling a theoretical telephone call system, in accordance with an example of the present disclosure; and

FIG. 29 is an illustration of the logic flow for preparing and presenting a real-time presentation, in accordance with an example of the present disclosure.

### DETAILED DESCRIPTION

To overcome the deficiencies previously described, the present disclosure is directed to a dynamic data modeling system for use in a real-time computerized presentation system, which allows for the presentation of dynamic data models which can be changed or varied in real-time such as during a presentation to an audience. Although the disclosure with reference to specific block diagrams, and table entries, etc., it will be appreciated by one of ordinary skill in the art that such details are disclosed simply to provide a more thorough understanding of the present disclosure. It will therefore be apparent to one skilled in the art that the present disclosure may be practiced without the entirety of these specific details.

The dynamic data modeling system for use in a real-time computerized presentation system provides significant improvements in computing systems used for providing presentations of data to viewer by allowing for the modeled data to be manipulated, adjusted, altered, and processed in real-time, thereby allowing for continued use of the data modeling system throughout a presentation. In contrast, conventional systems used for computer-based presentations are adjustable only by pausing or ending the presentation, reopening a slide and redoing it manually and then restarting the presentation. These conventional systems, such as MICROSOFT® POWERPOINT®, have no data input ability while in a presentation mode, and therefore are unable to provide for real-time adjustments of the data being presented in the presentation mode or even in the assembly mode.

While the subject application is expected to have benefits in a number of industries which use computer-based presentations, an exemplary use of the subject disclosure is within the B2B sales industry, and in particular, within the B2B sales industry for software products. For example, the subject disclosure may be used as a computerized presentation system within the B2B sales community to dynamically manipulate or adjust numerical models resulting from changes in real-time of data values within the numerical models to see the impact of those changes. These numerical models may include various mathematical and arithmetic-based models, such as, for example, product-specific financial models, such as financial models for deriving the forecasted value of using a new software product to a company's profit.

The ability to provide dynamic models in real-time to viewers of such a sales presentation significantly improves over the current industry techniques, which rely on B2B salespeople reworking entire presentations which typically involve pre-prepared spreadsheets, such as MICROSOFT® Excel spreadsheets, when a prospective purchaser of the product being offered for sale wants to find out the effect of adjusting one portion of the model. With conventional presentation systems, there is no tool or system available to the salespeople to easily vary data to see the total impact of a change in one or more data fields. In contrast, in the subject disclosure, a salesperson can adjust a model by manipulating various data input fields and controls (e.g., slider bars) positioned on the presentation itself, which act to change the underlying data in the model. The entire presentation then updates in real-time, such that all other models impacted by the data change, including cash flow summary models and business cases, are updated when the underlying data for one model is updated. Accordingly, the subject disclosure allows a sales person to adjust a computerized numerical model in real-time without having to navigate from a graphical display of the model, such that a viewer can maintain visual contact with the graphical display of the presentation.

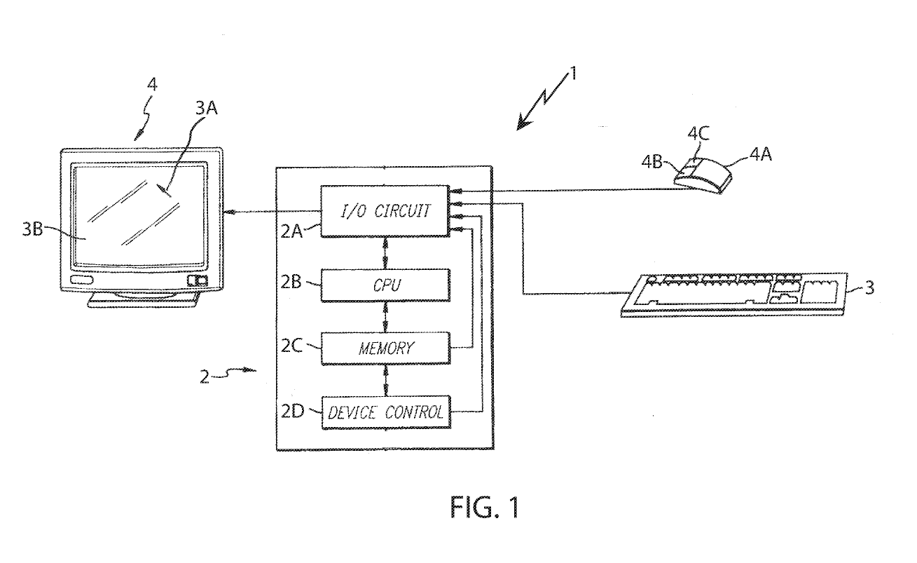

FIG. 1 is a diagrammatical illustration of computing architecture 1 on which a dynamic data modeling system can be operated, in accordance with an embodiment of the subject disclosure. As illustrated, the computing architecture 1 includes a computing device 2 which comprises four major components. The first of these is an input/output (I/O) circuitA, which is used to communicate information in appropriately structured form to and from other portions of the computer 2. In addition, computer 2 includes a central processing unit (CPU) 2B coupled to the I/O circuit 2A and to a memory 2C. These elements are those typically found in most computers and, in fact, computer 2 is intended to be representative of a broad category of data processing devices, which may include desktop computers,laptop computers, tablet computers, mobile computing devices, enterprise computing device, and others.

Also shown in FIG. 1 is a keyboard 3 may be provided for inputting data and commands into computer 2 through the I/O circuit 2A, as is well known. It will be appreciated that additional devices may be coupled to the computer 2 for storing data, such as magnetic tape drives, attached and remote hard drives, CD's, buffer memory devices, and the like. A device control 2D is coupled to both the memory 2C and the I/O circuit 2A, to permit computer 2 to communicate with multi-media system resources. The device control 2D controls operation of the multi-media resources to interface the multi-media resources to the computer 2.

A display monitor 4 is coupled to the computer 2 through the I/O circuit 2A. A mouse or other form of cursor control device 4A may permit a user to select various command modes, modify graphic data, and input other data utilizing switches 4B and 4C. More particularly, the cursor control device 4A permits a user to selectively position a cursor 3A at any desired location on a display screen 3B of the display 4. The display 4 may include any type of computerized display, such as a computer monitor, a projector screen, or other graphical user interface. It will be appreciated that the cursor control device 4A and the keyboard 3 are examples of a variety of input devices which may be utilized in accordance with the teachings of the present disclosure Other input devices, including for example, trackballs, touch screens, data gloves or other virtual reality devices may also be used in conjunction with the disclosure as disclosed herein.

Many embodiments of the disclosure may take the form of computer-executable instructions. Certain aspects of the disclosure can be embodied in a special-purpose computer or data processor that is specifically programmed, configured or constructed to perform one or more of the computer-executable algorithms described below. Accordingly, the term “computer” as generally used herein refers to any data processor and includes Internet appliances, hand-held devices (including palm-top computers, wearable computers, cellular or mobile phones, multi-processor systems, processor-based or programmable consumer electronics, network computers, minicomputers) and the like.

The disclosure also can be practiced in distributed computing environments, where tasks or modules are performed by remote processing devices that are linked through a communications network. Moreover, the disclosure can be practiced in Internet-based or cloud computing environments, where shared resources, software and information may be provided to computers and other devices on demand. In a distributed computing environment, program modules or subroutines may be located in both local and remote memory storage devices. Aspects of the disclosure described below may be stored or distributed on computer-readable media, including magnetic and optically readable and removable computer disks, fixed magnetic disks, floppy disk drive, optical disk drive, magneto-optical disk drive, magnetic tape, hard-disk drive (HDD), solid state drive (SSD), compact flash or non-volatile memory, as well as distributed electronically over networks including the cloud. Data structures and transmissions of data particular to aspects of the disclosure are also encompassed within the scope of the disclosure.

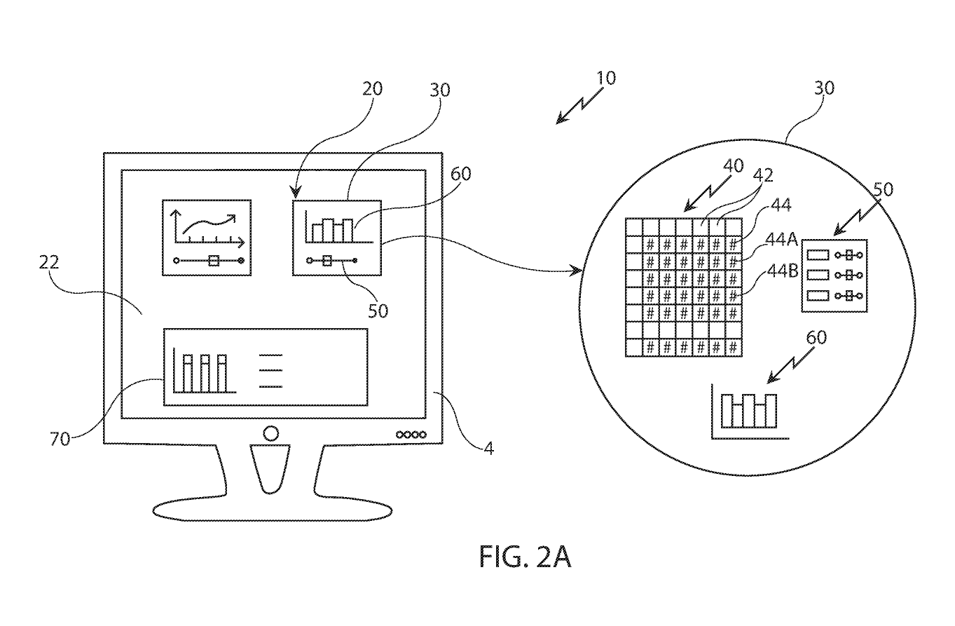

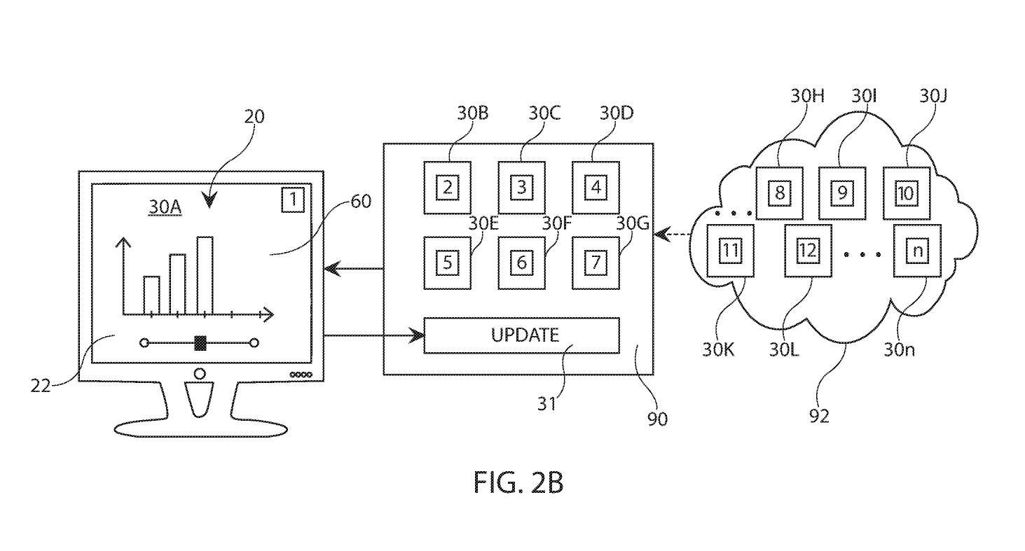

FIG. 2A is a schematic diagram of a dynamic data modeling system 10, in accordance with an embodiment of the present disclosure. As shown, the dynamic data modeling system 10, which may be referred to as ‘system 10’ includes a presentation engine 20 having a visual interface 22 displayable on the display screen 4 of a computerized device. The computerized device (FIG. 1) has a processor and a non-transitory memory. A plurality of computerized numerical models 30 is stored in the non-transitory memory. All of the numerical models 30 are importable into the presentation engine 20. All of the plurality of computerized numerical models 30 includes a data grid 40 having a plurality of data cells 42, wherein the plurality of data cells 42 are arranged by columns and rows, wherein numerical data values 44 arc stored within at least a portion of the plurality of data cells 42. The computerized numerical models 30 also include at least one data input field 50 controlling a manipulation of a first numerical data value 44A using a mathematical function applied to a second numerical data value 44B in a second data cell of the data grid 40. The computerized numerical models 30 further include a numerical model display 60 displayed on the visual interface 22. The numerical model display 60 is based, at least in part, on the first numerical data value 44A from the first data cell, and the numerical model display 60 is changed in real-time based on the manipulation of the first numerical data value 44A. A numerical model summary 70 is used to combine the numerical data from each of the plurality of computerized models 30 imported into the presentation engine 20, wherein the numerical model summary 70 is displayable on the visual interface 22.

For clarity in disclosure, the subject disclosure is described herein with reference to a company sales environment where a salesperson is providing a sales demonstration to a viewer using the dynamic modeling system, however, the use of the system 10 is not limited to the company, business, and corporate sales environment, as it may be used in other industries and environments. The presentation engine 20 may be the software presentation interface in which the dynamic modeling system 10 can be used. The presentation engine 20 may have a variety of visual interfaces 22, such as various screens or pages of the software where data can be displayed to a human viewer. The presentation engine 20 may be operated on various computing devices with the viewable content of the visual interfaces 22 being displayed on the display screen of GUI 4 of the computer device.

In conventional computerized presentation displays, the data being displayed is static, in that it does not and cannot change during the presentation absent the presenter or another individual reworking the underlying foundation of the presentation. When a salesperson needs to change the data that a presentation is based on, e.g., by changing a value, time period, or other factor, the salesperson presenting to the viewer is forced to use multiple applications throughout the presentation. For example, the salesperson may be required to switch between an Excel spreadsheet, a web based calculator, an external database, or another application in order to provide real-time manipulations and adjustments of the presentation, all of which act to disrupt and interrupt the presentation. The subject disclosure solves this shortcoming by allowing the data being presented to a viewer, whether numerical data, graphical data (bar graphs, line graphs, etc.), or another type of data, to be adjusted or altered in real-time based on the presenter's actions and all while maintaining view of the presentation.

FIG. 2B is a schematic diagram of a dynamic data modeling system 10 during presentation mode, in accordance with an embodiment of the present disclosure. The presentation occurs after the models 30 are created and imported into the presentation engine 20, for example, after a salesperson has created a presentation with the models 30 to be presented to a prospective company in a sales conference. Throughout the presentation, the salesperson will display different models to the audience on a visual interface 22 of the presentation engine 20 displayed on the computer monitor 4. In some presentations, a large number of models 30 may be used which can complicate the updating of other models 30 which have yet to be displayed. Specifically, when a large number of models 30 are used, the processor of the computer on which the presentation engine 20 is operated can become overwhelmed, which can result in failures in loading future models, lag times in updating the data of the models 30, and other undesired effects. These problems can prevent timely, seamless transitions of the models 30 during the presentation, which can affect the overall success of the presentation. Additionally, the memory 90 of the computer on which the presentation engine 20 is run may not be large enough to store all models 30 within a given presentation at once.

As shown in FIG. 2B, in one embodiment, when the presentation engine 20 is placed in presentation mode, the system 10 may display a first model 30A (e.g., model #1), have a select quantity of other models 30B-30G (e.g., models #2-7)) loaded into a memory 90 of the computer from which the presentation engine 20 is operated, and have an additional quantity of models 30H-30ₙ (e.g., models #8-n) stored in a remote database, such as a database hosted on the cloud or a server external of the memory 90. The models 30B-30G stored in the memory 90 are the next models 30 to be displayed consecutively after the first model 30A, while the models 30H-30ₙ are the later models 30 to be displayed. As the presentation is given and the salesperson adjusts or manipulates the data within the first model 30A, the models 30B-30G stored in the memory 90 are updated in real-time (schematically shown at block 31). However, the models 30H-30ₙ are not updated until they are loaded into the memory 90. This configuration allows successful real-time updating of the next models 30 to be displayed without overburdening the processor by attempting to update all models 30 within a given presentation. As the salesperson finishes with the first model 30A and moves on to the second model 30B, the next model 30H within the remote database 92 is retrieved and loaded into the memory 90, where it is updated with the adjustments made throughout the presentation thus far. This process continues until the presentation is complete.

This system for preparing models 30 for presentation so they are ready when the salesperson requires them allows for the presentation to proceed with real-time updating of the models 30 to be used next, while at the same time not overburdening the processor or the memory 90 of the computer by trying to update all models 30 at once. In this example, six models are stored on the memory 90 of the computer at a given time, but the number of models 30 stored on the memory 90 versus stored on the remote database 92 may vary by design of the system 10.

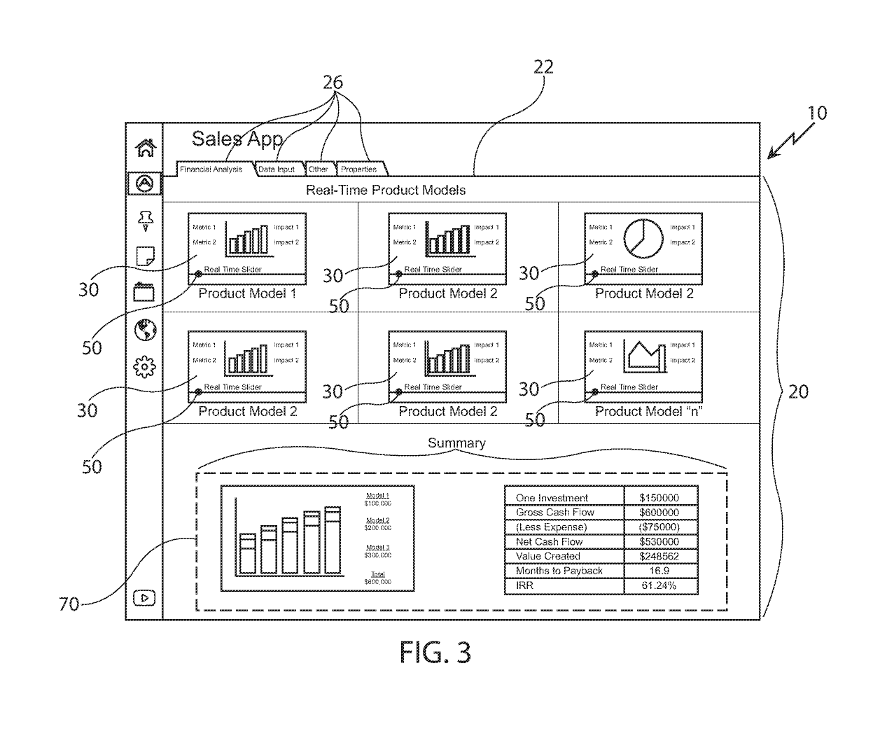

FIG. 3 is a diagrammatical illustration of the presentation engine 20, in accordance with an embodiment of the present disclosure. In the presentation engine 20 of the subject disclosure, the computerized numerical models 30, which may be referred to herein as ‘model 30’, can be displayed on the visual interface 22 of the presentation engine 20 and updated in real-time using various data input fields 50, which may be used to allow adjustment of data input by the user by manipulating numerous interactive controls such as sliders, dials, buttons, etc., as depicted in FIG. 3. As computerized numerical models 30 are being displayed on the visual interface 22, the user can make changes to the entire presentation by adjusting the data within the data input field 50, and models 30 are updated in real-time.

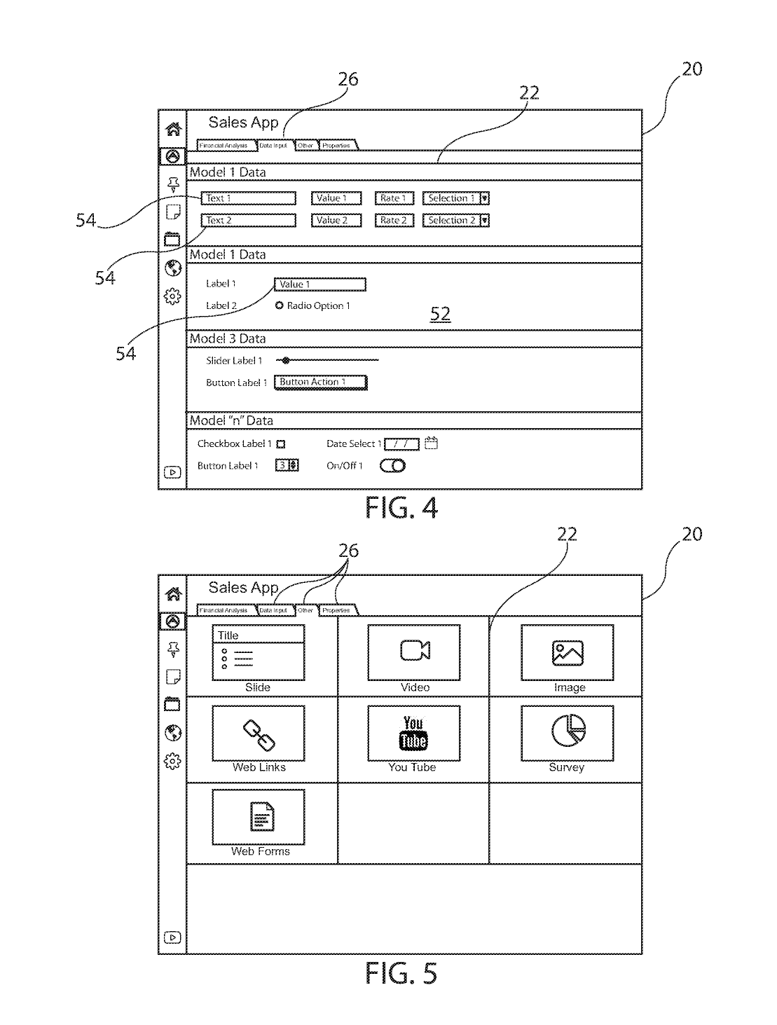

It is noted that the data input field 50 may include different types of interactive controls to adjust, manipulate, update, and otherwise change the baseline metrics of a model 30. While different types of data input field 50 may be used, one preferred type of data input field 50 is a slider or slide bar, which can be depicted as a linear bar representing a range of data where the user can select a particular location along that linear bar to select a specific data value within the range. The slider can also be implemented in other configurations where the user is allowed to select a data value within a range, or a data value independent of a range, all of which are considered within the scope of the present disclosure. The presentation engine 20 may include various different visual interfaces 22, each of which may be accessible by selecting a tab 26 within the presentation engine 20. FIGS. 4-6 are diagrammatical illustrations of visual interfaces 22 of the presentation engine 20, in accordance with an embodiment of the subject disclosure. As shown in FIG. 4, the presentation engine 20 may include a visual interface 22 with a data input page 52, where the user can input, any of the data values within the various data input areas 54 associated with each model 30. Using the example of a B2B sales environment, the models 30 may include real-time product models that show the value of a particular product, which may require product specific data to by input by the user. The model 30 may use the data to calculate financial impacts associated with the product purchase during the B2B sales presentation.

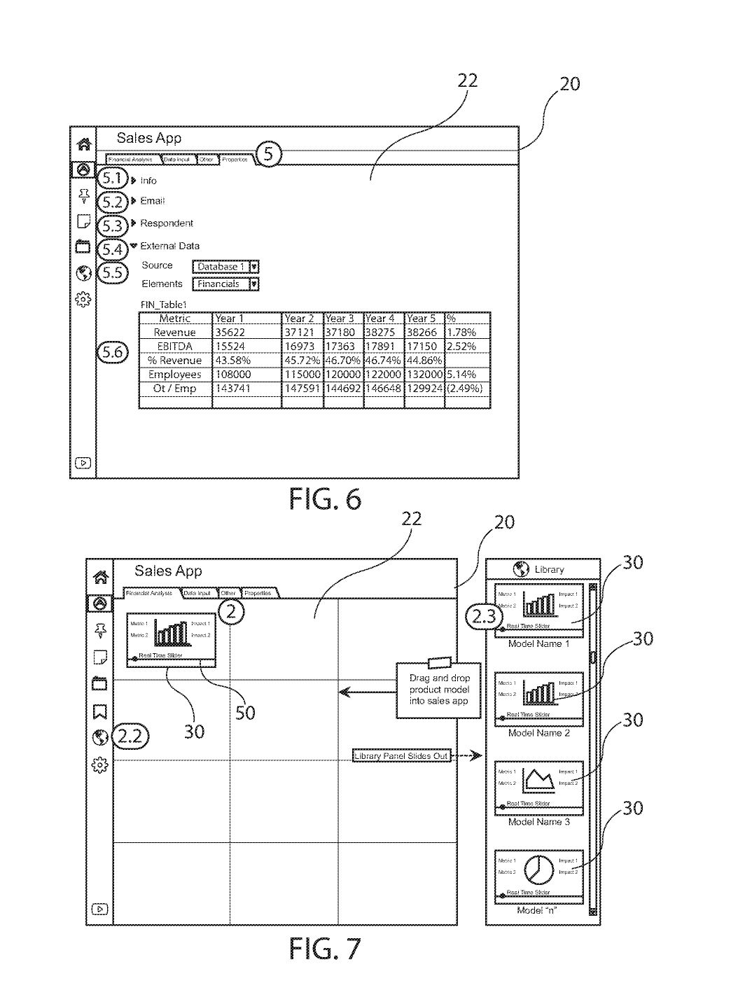

In FIG. 5, the visual interface 22 is an external content page where the user giving the presentation can access data from various external data sources or databases. The other types of content that can be included in a presentation may include slides, uploaded videos, images, web links, web-hosted videos (e.g., YouTube), surveys, and web forms, among other types of content. This content can be updated in real-time, as needed, in the presentation. Additionally, the content data can be used to adjust the presentation and/or a model 30. For example, the results of a survey conducted on an external survey system can be incorporated into a presentation or the real-time price of a stock or commodity can be incorporated into a model 30. The presentation engine 20 may be capable of supporting any type of content. In FIG. 6, the visual interface 22 may include a properties page where the user can configure how the presentation engine displays various data. Here, the user may input information about the presentation, share the presentation via a web-link using an editable email template, input respondent information, connect or otherwise incorporate external data sources into the presentation, select a specific data source, and select the data elements to be used in presentation. Once selected, external data can be used anywhere in the presentation and updates when the source data updates.

FIG. 7 is a diagrammatical illustration of one example of creating the presentation engine 20, in accordance with an embodiment of the subject disclosure. As shown, to create a presentation using the presentation engine 20, the user may select the library icon and a library panel becomes accessible. Then, the user may select the desired computerized numerical model 30 by double clicking it or otherwise selecting it to add it to the presentation. It is also possible to add a model 30 to the presentation engine 20 by dragging and dropping an icon representing the model 30 onto the presentation engine 20. Once the model 30 is imported into the presentation engine 20, the user may click the data tab and may input product specific data specific to the model 30 selected. Next the user interacts with each model 30 via the interactive controls of the data input field 50 such as sliders, buttons, dials etc. to model the value of the products and services being proposed.

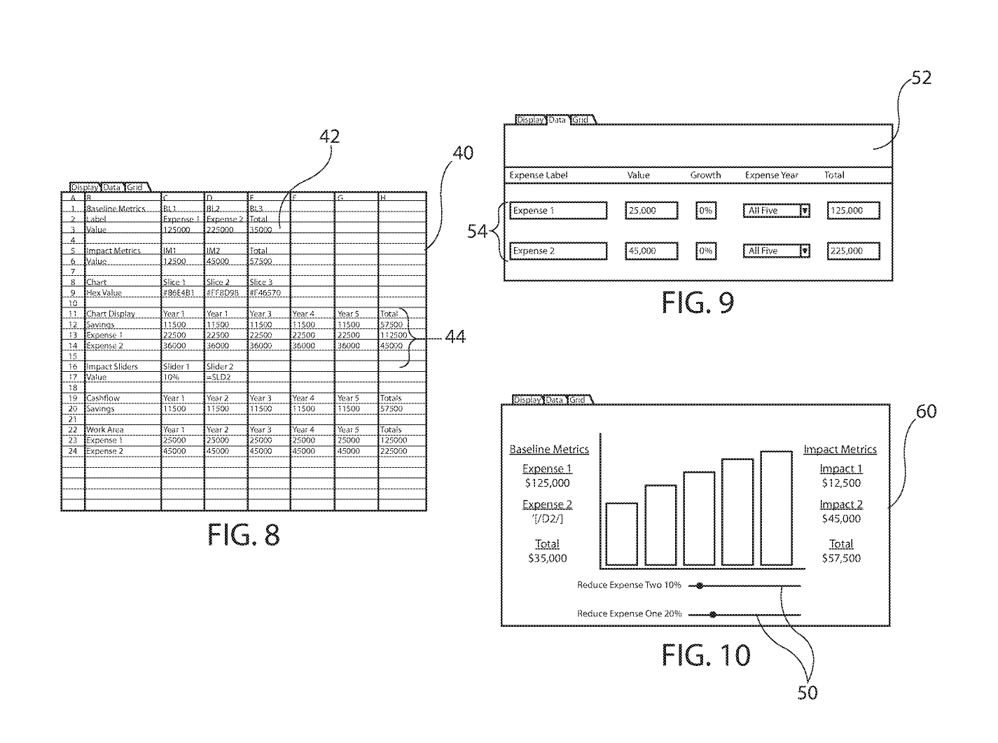

Each of the plurality of computerized numerical models 30 may generally include three main components: the data grid 40, a data input areas 54, such as contained within a data input page 52, and the numerical model display 60, as discussed relative to FIGS. 8-10. FIG. 8 is a diagrammatical illustration of the data grid 40, in accordance with an embodiment of the subject disclosure. The data grid 40, which may be referred to simply as ‘grid’ herein, may function like a spreadsheet with data cells 42 (also referred to as ‘cells’ or ‘grid cells’) organized by rows, columns, and mathematical calculations or functions between the data values 44 within various data cells 42. The mathematical calculations may include any mathematical function, such as addition, subtraction, division, and multiplication, which may occur between any two or more data cells 42 of the same or different models 30, or between data cells 42 and external data sources. The data grid 40 carries out the calculations used by the model 30, updates the model display 60. The mathematical engine within the data grid 40 may support many standard spreadsheet functions/calculations, but also provide functions which are unique to individual models 30.

FIG. 9 is an illustration of the data input page 52 having data input areas 54, in accordance with an embodiment of the subject disclosure. The data input areas 54 are where users may enter data used by the model 30. The data input areas 54 of the data input page 52 allow a user to input data values into the data grid 40. The data input areas 54 may set the current state of the chart and/or graph, set a range of a chart and/or graph, and update the impact metrics of the model 30. With this data determined through the data input areas 54, the user can then use the data input fields 50 (FIGS. 3, 7, 10, for example) to adjust and manipulate this data in real-time during a presentation. The data input page 52 is configured using various input fields such as, but not limited to, textual data, images, numbers, option lists, radio buttons, check boxes, sliders, tabs, etc. Fields are given variable names that can be referenced in the data grid 40 and the model display 60.

FIG. 10 is an illustration of the numerical model display 60, in accordance with an embodiment of the subject disclosure. As shown, the model display 60 may be the portion of the model 30 where the users view graphical data of the model 30 and interact with the model 30. This layer contains the model elements such as charts, sliders, metrics, dials, images, text, etc. The model display 60 may present the data that is calculated in the data grid 40 and which can be adjusted by altering the data input fields 50. Dynamic data (calculated in the grid) is presented in the model display 60.

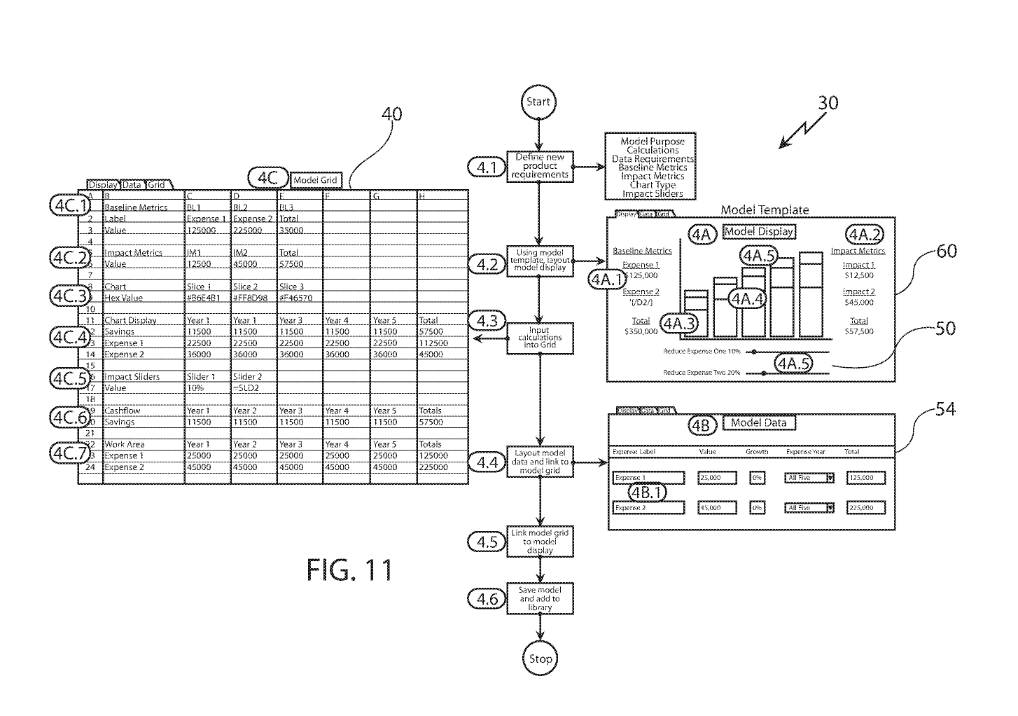

FIG. 11 is an illustration with flow chart of one example of how the model 30 is built, in accordance with an embodiment of the subject disclosure. In particular, the model 30 of FIG. 11 is an expense model. In this example, the salesperson may input a current expense of the prospective purchasing company, for example, “Expense 1” ($25,000 per year) and “Expense 2” ($45,000 per year). The baseline metrics may be update to show the expenses over 5 years ($125,000 and 225,000). In this example, the salesperson may be proposing to the prospective purchasing company that the product the salesperson is selling will reduce Expense 1 by 10% and Expense 2 by 20%. To reflect the impact, the salesperson may move slider 1 to 10% and slider 2 to 20%. The 5 year savings is reflected in the impact metrics. As shown at block 4.1, when there is a need to create a new product model, such as for a new type of sales industry, the model designer may first define the model purpose and user requirements. In practice, models 30 may be created by a model designed and published in the library. Salespeople may then use the models 30 created by the model designer. In limited circumstances, a salesperson may design a model 30. After the model requirements are defined, as shown in block 4.2, the user (salesperson) may login into the system and open the model template to the model display tab. The system provides a menu of model elements that can be “dragged and dropped” in place on the model display canvas. Model designs are only limited by the imagination of the model designer.

Next, as shown at block 4.3, the model designer inputs the model calculations into the data grid 40. Ultimately, the model display 60 and the model data 50 are driven in real-time by calculations in the data grid 40. Later, the model designer may link the model display 60 and model data input areas 54 to cells 42 within the data grid 40. To build the model 30, the model designer may input data values 44 and calculations into the data grid 40. For example, using the expense model of FIG. 11, the model designer may make input various metrics, including any of the following:

Baseline Metrics (indicated at position 4C.1 in the data grid 40), may show the current state of the customer's environment i.e. the current expenses. That is, it shows the base numbers representative of the current way the customer's business is operating using its present software or other tools. For example, the formula in C3 is “=H23” ($125,000), which is the 5 year sum of Expense 1. This section will be linked to the baseline section in the model display using a bracket notation* i.e. [/C3/]. Data values 44 in cell C3 will be instantly reflected in the model display—the bracket notation tells the model to replace the notation with the value of cell C3.

Impact Metrics (indicated at position 4C.2 in the data grid 40) may show the impact the new or proposed product being offered will have on the business as the user moves the impact sliders of the data input fields 50. This section may be linked to the impact baseline section in the model display 60 via bracket notation to show the relationship or comparison between the Baseline Metrics and the Impact Metrics.

Chart Color (indicated at position 4C.3 in the data grid 40) may contain the hex color values of the chart. When a chart is added to the Model Display 60, it may be linked to this cell range (C9:E9) to get color values.

Chart Display (indicated at position 4C.4 in the data grid 40) may show the range of data to be displayed in the chart. When a chart is added to the Model Display 60, it may be linked to this cell range (B11:G14) to display the chart.

Impact Sliders (indicated at position 4C.5 in the data grid 40) may be connected to the impact sliders of the model display 60. For example, the second slider in model display has a variable name SLD2, which ranges from 0 to 100. When the slider is moved it generates a value (20) and that value is stored in the variable SLD2. The cell D17 in the grid is set to SLD2 i.e. =SLD2. As the user moves the slider, the value in D17 is equal to the value of the slider and produces a range of financial impacts.

Cash Flow (indicated at position 4C.6 in the data grid 40) may show a unique characteristic of a product model is that it outputs the cash flow impact of the product. Product cash flows are shared at an application level with a specialized model or a summary model.

Work Area (indicated at position 4C.7 in the data grid 40) may be the arca to perform intermediate calculations. These calculations are typically not shown in the model display, but are part of the final calculations.

With this example, the use of bracket notations, e.g.,“[/Variable Name or Cell Reference/”, where the variable name or cell reference between the brackets is replaced by actual corresponding values from the data grid 40, may be a convenient method to update dynamic data in the presentation engine and/or models 30.

Next, at block 4.4 of FIG. 11, the layout of the model data values 44 may be determined and linked to the data grid 40. Continuing with the expense model example, in order to calculate a financial impact, product models require data input from the customer's environment specific to the product being sold. Model data values 44 can be input into the model grid 40 using the model data tab. When creating a new model 30, the model designer must layout the model data-tab. Again, the model designer can “drag and drop” various field types on to the model data canvas of the presentation engine 20 interface. When applicable, fields can be assigned variable names to be used in calculations

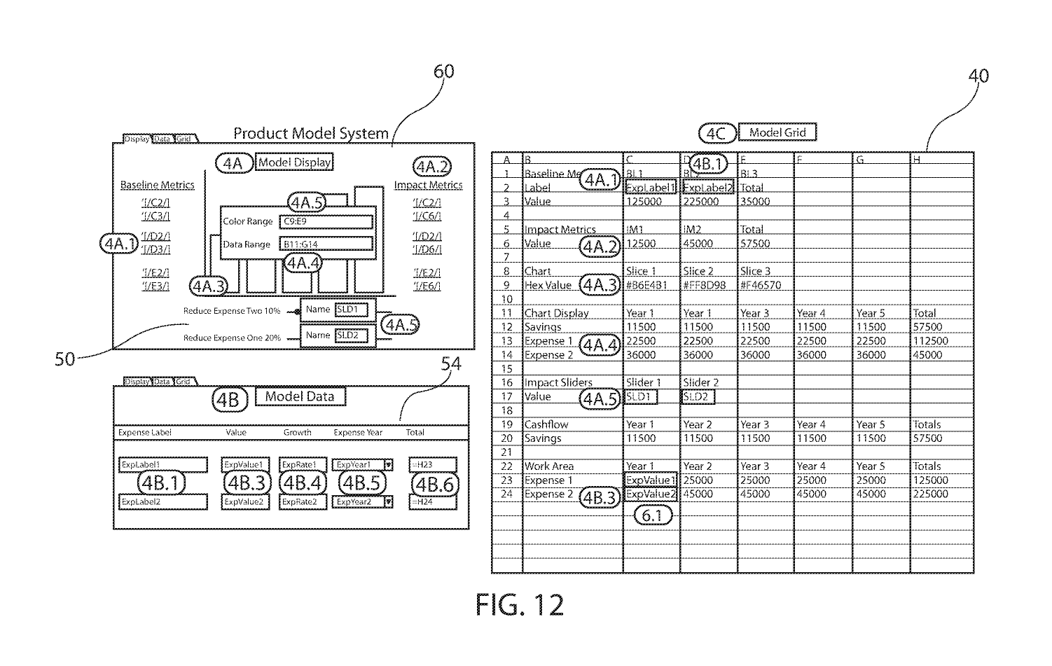

With the model template elements complete, the next step is to link the grid to the model display and the model data, which is shown at block 4.5 of FIG. 11. This step may enable data between the model display 60, data input areas 54, data input fields 50, and data grid 40 to be exchanged in real-time. FIG. 12 is a diagrammatical illustration of block 4.5 of FIG. 11, in accordance with an exemplary embodiment of the subject disclosure. Specifically, FIG. 12 provides an example of how the data can be linked between the model display 60, data input areas 54, data input fields 50, and data grid 40. Referring first to the model display 60 of FIG. 12, at position 4A.1 the baseline metrics are connected to the gird via Bracket Notation, where [/variable name or cell reference/] is dynamically replaced with the value of the variable or cell reference. As the diagram shows, the baseline metrics are connected to cell range C2:E3 in the grid. Next, at position 4A.2 impact metrics are connected to cell ranges C2:E2 and C6:E6. At position 4A.3, the chart color is connected to C9:E9. At position 4A.4, the chart range is connected to B11:G14.

Referring now to the model data input areas 54 of FIG. 12, at position 4B.1, two text fields are given names that can be varied for each application and are shown here as ExpLabel1 and ExpLabel2. Cell C2 and D2 have been set equal to the variable name, i.e. “=ExpLabel1”. The data that the user enters into the field is reflected in the grid cells. At position 4B.3, two number fields have variable names ExpValue1 and ExpValue2 and cell C23 and C24 have been set equal to the variable names. Next, at positions 4B.4-4B.5 data input areas 54, ExpRate 1 & 2 and ExpYear 1 & 2, can be used in calculations in the grid. At position 4B.6, two text display fields may display the value of cells H23 and H24.

It is noted that various programs have been used in the industry to build analyze models, such as visual analytics software like Xcelsius™. However, these programs generally provide a dashboard which pulls data from multiple data sources and consolidates information into a single screen, as opposed to creating models. The models 30 of the present disclosure may incorporate similar tools as other visual analytics software, but the function and output is different. For example, the models 30 of the subject disclosure show the financial impact of a specific product, as opposed to merely displaying metrics from various data sources. Additionally, the models 30 require product specific data to be input by the model designer or user, which is used in calculations. The models 30 also output product specific cash flow data that can be used by other models.

Referring back to FIG. 11, once a model 30 is complete, it is saved and added to the model library where it can be easily accessed, such as by clicking the library icon which causes the library panel to slide out, displaying a list of models that can be added to the app either by double clicking on the model or via drag and drop. This is shown at block 4.6. Or course, once an old model is called up, it must be edited to include new numbers for the new customer or new product.

It is noted that the model building described relative to FIGS. 11-12 may have significant advantages over the conventional art. As previously discussed, during conventional sales presentations, a typical sales person would necessarily need to rely on a one or more manually-created spreadsheet, such as an Excel® spreadsheet. These one or more spreadsheets are fixed and cannot be changed without changing slides of the presentation or removing the slides from a presentation mode. In contrast, the system 10 allows an unlimited number of product models to be combined in real-time. Thus if one is selling multiple products, the seller can show the impact of the combination. Additionally, the models 30 arc infinitely reusable and can be easily modified when features change. They also have consistent functionality for ease of use and enable a presentation different from merely displaying a spreadsheet. Additionally, once new models are added to the library, they may be available instantly enterprise wide.

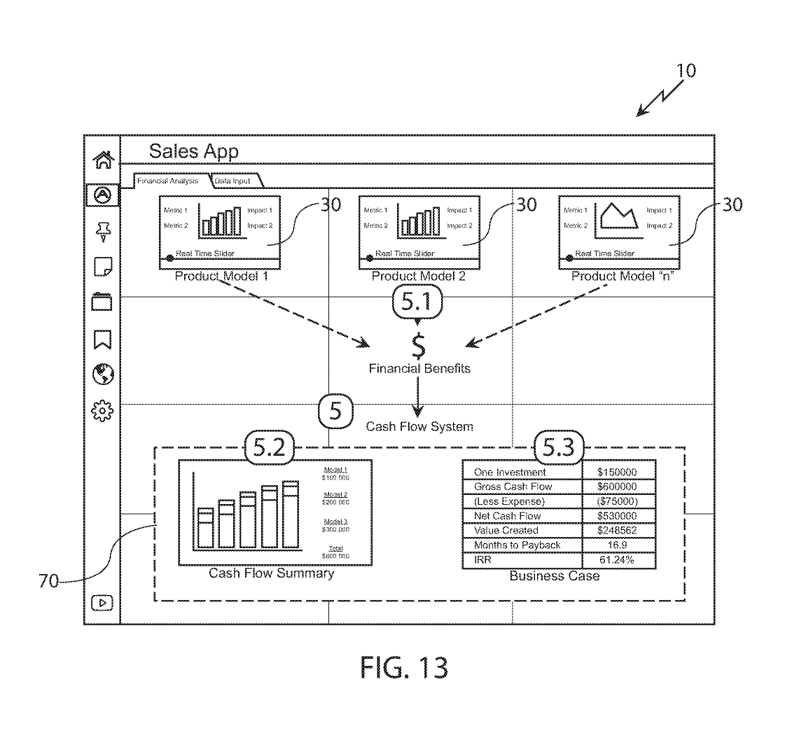

Once the models 30 have been built and they have been imported into the system 10, the user of the system (salesperson) may be able to utilize the combined data of the models 30 to enhance the presentation. Using the previous example of employing the system 10 in a company sales environment, the salesperson may be capable of analyzing the combined data from the models 30 to output the numerical model summary 70. FIG. 13 is a diagrammatical illustration of the system 10 depicting the model summary 70, in accordance with an embodiment of the subject disclosure. In one example, this summary 70 may be referred to as a ‘cash flow’ summary which provides the viewers of the presentation with both cash flow summary data and business case data.

Continuing with the previous example, the output from each model 30 can be combined into the cash flow summary to create a business case. Here, if the seller has three product models 30 in the presentation engine 20 (FIG. 3), once the models have been adjusted, i.e., when data has been input and the sliders adjusted, each model outputs its cash flow. In this example, model 1 may output $20K per year for five years totaling $100K, model 2 may output $40K per year for five years totaling $200K, and model 3 may output $60K per year for five years totaling $300K. The cash flow system analyzes the cash flow output from each product model and summarizes the data in a cash flow model, such as by using a graphical representation of the numerical data. The cash flow system also makes the data available to the business case model, which automatically creates a business case.

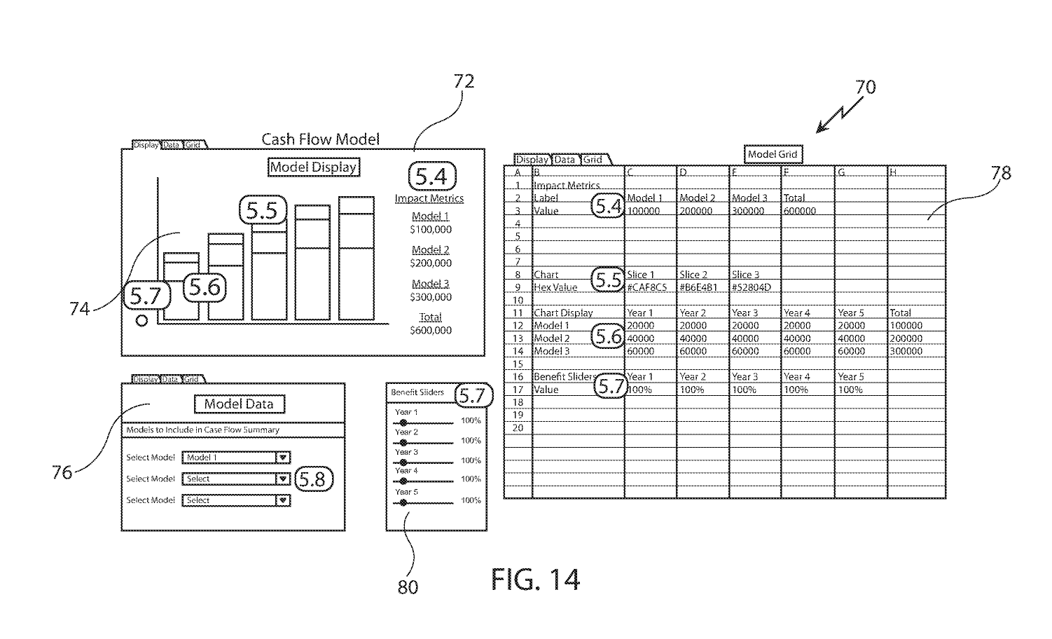

FIG. 14 is a diagrammatical illustration of the system 10 depicting the model summary 70, in accordance with an embodiment of the subject disclosure. Specifically, FIG. 14 illustrates the operation of the numerical model summary 70, i.e., the cash flow summary in the present example. Continuing with the example, the cash flow model 72 is part of the cash flow system and works similarly to models 30, as previously described. The model display 74 and model data 76 of the cash flow model 72 may connect to combined summary data grid 78 and update in real-time. Similar to the models 30, the cash flow model may use impact metrics which connect to the grid 78 using bracket notation, discussed previously. Every model 72 in the system may have benefit sliders which are used to adjust variable in the summary 70, such as the “timing” of the cash flows. For example, if an implementation happens in the middle of year 1, the company will not receive 100% of the benefits (cash flow) in year 1. Benefit sliders allow users to adjust (decrease or increase) the cash flow year-by-year to accurately reflect the timing of the benefits. In models 30, the data input fields 50 allow for the adjustment of variable, such as cash flow, for each particular model 30. Every model 30 in the system 10 may use the data input fields 50, such as sliders, and the summary models 72 may use the benefit sliders 80. Thus, the individual models 30 can be adjusted at the individual level and the benefit sliders 80 can be used to adjust the cash flows for all models 30. In the cash flow model 72, benefit sliders adjust the cash flow benefits from all models 30 which have been combined into the cash flow model 72. Next, the model data 76 allows the user to select which of the models 30 to include in the cash flows. There are times when a seller will present a model 30 but not want to include it in the cash flows, for example, if the data in the model 30 may not be verifiable and therefore reduce the credibility of the business case. Rather than taint the business case, the seller can omit the model 30 from the analysis.

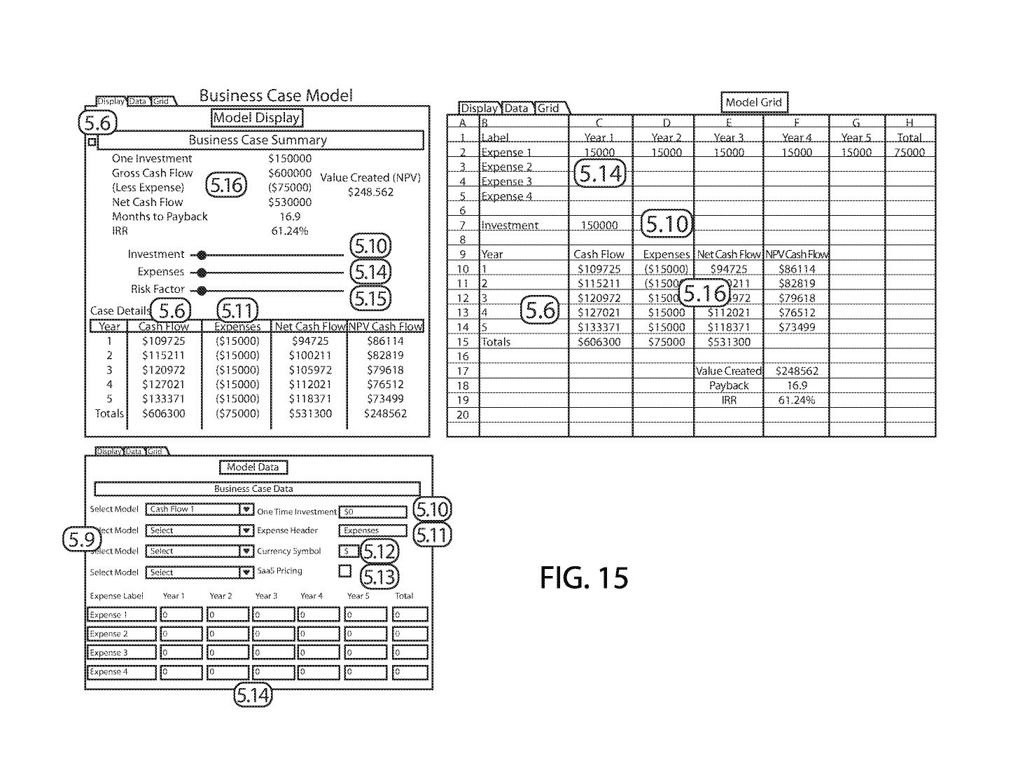

FIG. 15 is a diagrammatical illustration of the system 10 depicting a business case model, in accordance with an embodiment of the subject disclosure. The business case model may be a result or conclusion reached through using the system 10. For example, the system 10 may analyze a product's impact on a company and the business case model may provide a justification for purchasing the product. The business case model receives cash flow data from the cash flow system and automatically produces a business case. The business case may calculate industry standard financial metrics such as net present value (NPV), internal rate of return (IRR), and Payback, among others.

Referring to FIG. 15, at position 5.6, the business case is presented in summary form. Users can check the case details box for a more detailed view of the cash flow data. Cash flow data is sent to the grid and displayed in the business case via bracket notation. At position 5.9, the business case data allows the user to determine how the business case will function. The user can select which cash flow models to include in the analysis if more than one is presented. This feature may be useful when conducting analysis for multiple business units (BU) within the same organization and each BU wants a separate business case. Next, at position 5.10, consideration can be given for capital purchases which require a one-time capital investment. The business case provides two options for inputting a capital investment: the investment slider or number entry. With the investment slider, as the user moves the slider to the right it calculates an investment amount. The investment calculation can be a formula of the sales team choosing. When seller is showing the value of their products, they know the cash flow benefits to the customer, but they may not know the amount of the investment, e.g. the solution may require engineering resources that are unavailable. The seller can use the investment slider to estimate the investment. More importantly, by moving the slider, the seller can determine how much investment the business case can support. With the input investment, the actual investment can be input. This option may be useful when the product costs are finalized. When the user inputs the investment, the business case model removes the investment slider.

Next, at position 5.11, the expense header may allow the user to customize the heading for ongoing expenses. Most product investments have ongoing expenses e.g. maintenance, support, licensing, etc. The header allows the user to use a name that reflects the expenses. At position 5.12, the user may select a currency symbol or choose to not use one at all. At position 5.13, the system may provide consideration for software as a service (SaaS), which has the benefit of little or no upfront capital. When SaaS pricing is check, the business case model transforms to a SaaS business case by removing the following elements: the one time investment option as there is no capital outlay; the expense slider—the seller inputs the annual SaaS expense; months to payback—there is no payback without capital outlay; and IRR—there is no IRR without capital outlay. At position 5.14, similar to the capital investment, there may be two ways to enter ongoing expense information: the expense slider or expense input. The expense slider may be used when estimating expenses. The ongoing expense calculation is at the discretion of the sales team. For example, it could be a percentage of the capital investment, which works for on premise software deployments. As an alternative to the expense slider, one may input the actual expenses. Use this option when expenses are finalized. When the user inputs the expense, the business case model removes the expense slider. Next, at position 5.15, a risk factor slider may be used to account for risks when making a product investment. When the slider is moved to the right, it discounts (lowers) the cash flows thereby reducing the overall business case. At position 5.16, at the business case summary, the cash flow system calculates the business case in the grid. The summary data is linked to the grid using bracket notation.

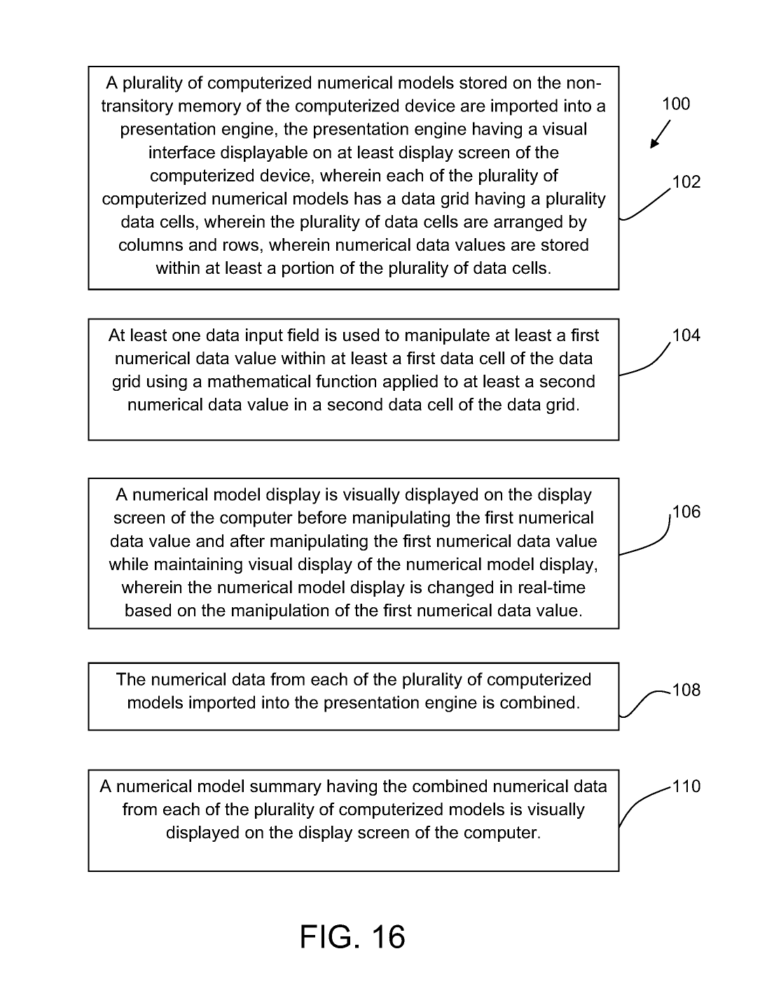

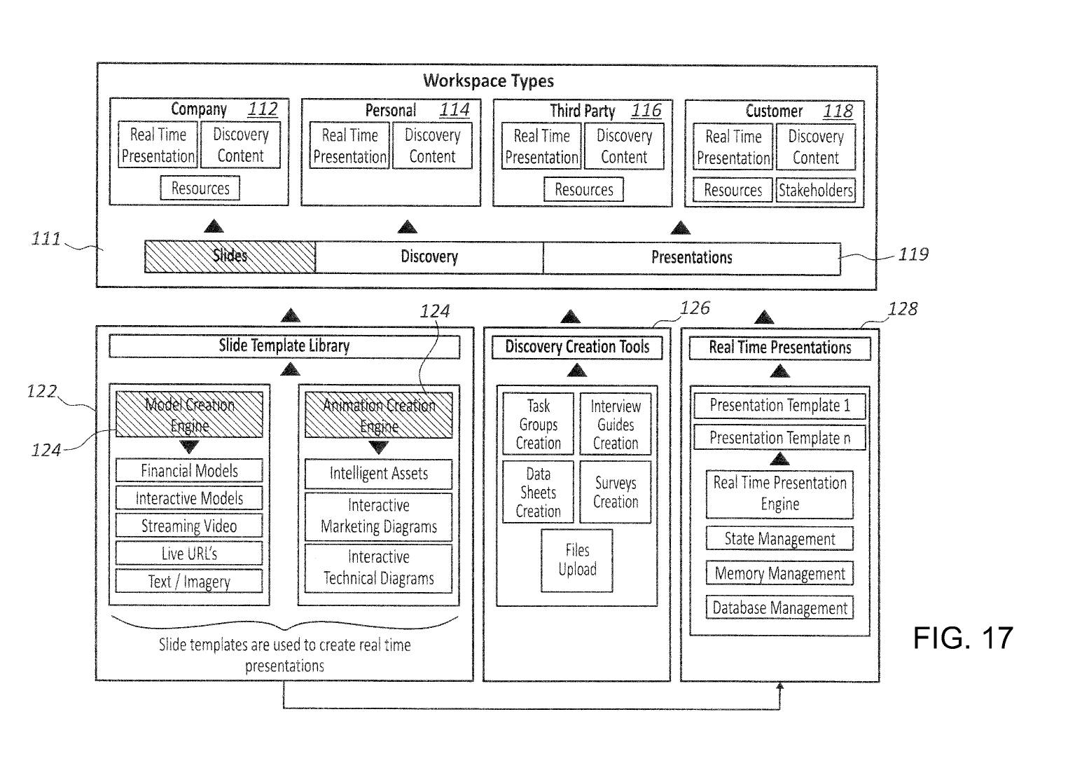

FIG. 16 is a flowchart 100 illustrating a method of modeling data for use in a real-time computerized presentation system, in accordance with an embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 102, a plurality of computerized numerical models stored on the non-transitory memory of the computerized device are imported into a presentation engine, the presentation engine having a visual interface displayable on a display screen of the computerized device, wherein each of the plurality of computerized numerical models has a data grid having a plurality of data cells, wherein the plurality of data cells are arranged by columns and rows, wherein numerical data values are stored within at least a portion of the plurality of data cells. At least one data input field is used to manipulate at least a first numerical data value within at least a first data cell of the data grid using a mathematical function applied to at least a second numerical data value in a second data cell of the data grid (block 104). A numerical model display is visually displayed on the display screen of the computer before manipulating the first numerical data value and after manipulating the first numerical data value while maintaining visual display of the numerical model display, wherein the numerical model display is changed in real-time based on the manipulation of the first numerical data value (block 106). The numerical data from each of the plurality of computerized models imported into the presentation engine is combined (block 108). A numerical model summary having the combined numerical data from each of the plurality of computerized models is visually displayed on the display screen of the computer (block 110). Many additional steps, variations, and functions may be included in the method described relative to FIG. 16, including any of the functions described with respect to FIGS. 1-15.

Example of the Present Disclosure in a Company Business Context:

To further describe how the system and method, described relative to FIGS. 1-16, may be used within the company sales environment, the following example describes how the subject disclosure can be a useful tool in enhancing company sales of large, high value items.

Within this example, the term “products” is used herein to refer to anything that one can sell including services, software, financial products, machines, vehicles and insurance. The term “big ticket” typically refers to something that has large value in proportion to the business. Thus a $3000 All-Terrain Vehicle (ATV) would be a relatively minor purchase for a very large company (sales revenues in excess of $1 billion) and a huge purchase for a very small company (sales revenues under $100K. The considerations in making the decision to buy could be quite similar, but staffing and management involvement could be quite different. Of course “big ticket” typically means and includes purchases of products the value of which can extend from perhaps around $100,000 USD to well above $10 million USD (e.g., a large jet airplane); but at the same time, it can also mean a relatively modest purchase involving a few thousand dollars which is sold for use in the production of income or other value.

Decision Information

Sales efforts to sell “big ticket” products prior hereto have typically included or focused on the “return-on-investment” (“ROI”) to the customer. That is, the value or cost to purchase the “big ticket” product or service would be compared to a financial model involving its use and the benefit obtained as a result of the purchase and use of the “big-ticket” product such as, for example, reduced labor cost, increased production; lower use of raw materials, and/or other comparable factors which can be quantified to show a financial benefit to be realized by the customer. While ROI was and still is certainly a factor of import to some if not many customers, it has been determined and is heretofore not been appreciated by sales personnel and sales teams that the focus must be shifted to both a total financial analysis coupled with a showing on how the “big ticket” product supports the business drivers of the customer. That is, the inventor has discovered that nearly every company will focus or look at the connection of the “big ticket” product to its business drivers that include growing revenue, controlling (e.g., lowering) costs, retaining customers and increasing work force productivity.

As to the financial factors, the purchaser today looks for a lot more than ROI and is now looking at a total financial analysis that involves the following factors: the amount of the investment; the cash flow generated by the “big ticket” product; the net present value (NPV) created by making the investment; the total return by making the investment; the payback period;

risk factors (e.g., a long payback period increases the risk of market change that could have a negative impact on the expected financial rewards projected at the outset); and an elasticity analysis (i.e., how changing an economic variable affects other variables).

Platform Architecture

The platform architecture is seen in FIG. 17. A unique system of workspaces 111 is provided each of which is in effect a file or series of files in the memory of a computer accessible when desired. Each of the workspaces 111 allows users to complete and retain work and reuse it for multiple applications. Thus, the user can retain real-time presentations, interview guides used to interview a stakeholder, data sheets, surveys and other related data because sales of the same products to different customers will typically involve very similar drivers. Thus one is able to save work from prior sales effort and reuse it for selling the same product to a different customer or selling similar or even different products because much of the data required is similar. As herein illustrated, the workspace types include a company workspace 112 useful for retaining materials that arc useful for any and all members of a sales team. The personal workspace 114 is useful for retaining information unique to each person who is working to promote sales and may be part of the user or sales team. The third party workspace 116 is for retaining information supplied by third party companies or as otherwise assigned. And the customer workspace 118 is for storing discovery information germane to a particular customer. Thus the members of a sales team may access all needed information, fill in or supply, correct and update and assemble information for effecting, for example, mapping to a business driver. The workspace system includes sub files or sub directories for real-time presentations, discovery content and other resources as indicted. A tool bar 119 allows the user to access libraries of different presentations to select desired materials for transfer into one of the workspaces 112, 114, 116 and 118.

In FIG. 17, we also see an alternative example of a model library 120 (as compared to FIG. 7) which can be accessed from any work space. The model library 120 includes an inventory of slides used for creating real-time presentations. The slides in the library are created using the model engine 122 or an animation using an animation engine 124. As seen in FIG. 17, the model library 120 includes whatever types of models that have been or could be created as indicated. Similarly the animation creation engine 124 also may access, for example, intelligent assets and other diagrams as seen in FIG. 17. The architecture of the system also has been structured to include discovery creation tools 126 that are useful to collect data for use in future sales efforts. The various tools are identified in FIG. 17 and logically include, for example, surveys, interview guides, and data sheets all as seen in FIG. 17. Also seen are real-time presentation tools 128 useful to create real-time presentations for use, for example, when presenting findings.

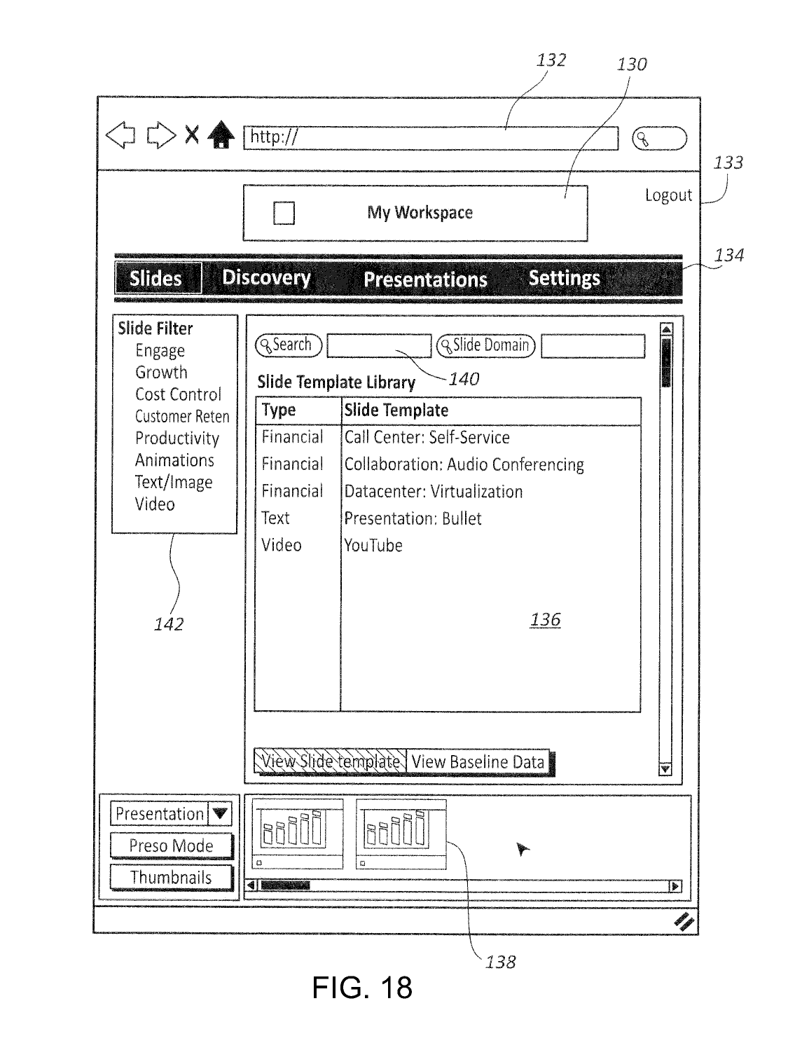

To interface with the various workspaces 112, 114, 116, and 118 in the computer system of the user configured to operate as herein disclosed, a user will call up and access the screen 130 a sample or example of which is illustrated as FIG. 18. The workspaces 112, 114, 116, and 118 are accessed by first accessing a remote server or main frame over the internet using suitable routing data that is entered into a search bar 132. Once accessed, the screen 130 will fill with data that has been collected or assembled for a particular presentation. With the screen 130 filled with applicable data, the user may access a desired workspace of FIG. 18 by selecting one using the screen button 133. The user may also use a search or navigation bar 134 to access categories of information as named in the bar. A library 136 of slide templates is identified so the user can access whatever template is desired. A current or active slide inventory for a current presentation 138 is present to allow the user to access any desired slide. The screen 130 also shows the availability of tools 140 to search for specific and desired slides as well as a filter 142 to sort slides by particular type. Tools 136 are also provided to deal with slides within a particular workspace.

Turning now to the model engine earlier identified, it uniquely has been created to replace and avoid use of a common tool used to present data referred to as a “spreadsheet.” Each spreadsheet is typically designed for a specific use to present data in a tabular or columnar form to show relationships. For business drivers, the impact areas will vary from customer to customer and from product to product so that a standard spreadsheet is not available. Only skilled users and operators are able to assemble or put together complex spreadsheets with complicated relationships. The model engine disclosed herein uniquely presents and processes data that shows cash flows for each impact area, supports virtually an unlimited series of models, and creates a “snap together” system that allows financial models to be assembled dynamically and in real-time. Further, the model engine incorporates functions that allow the system to reflect changes in cash flow in real-time.

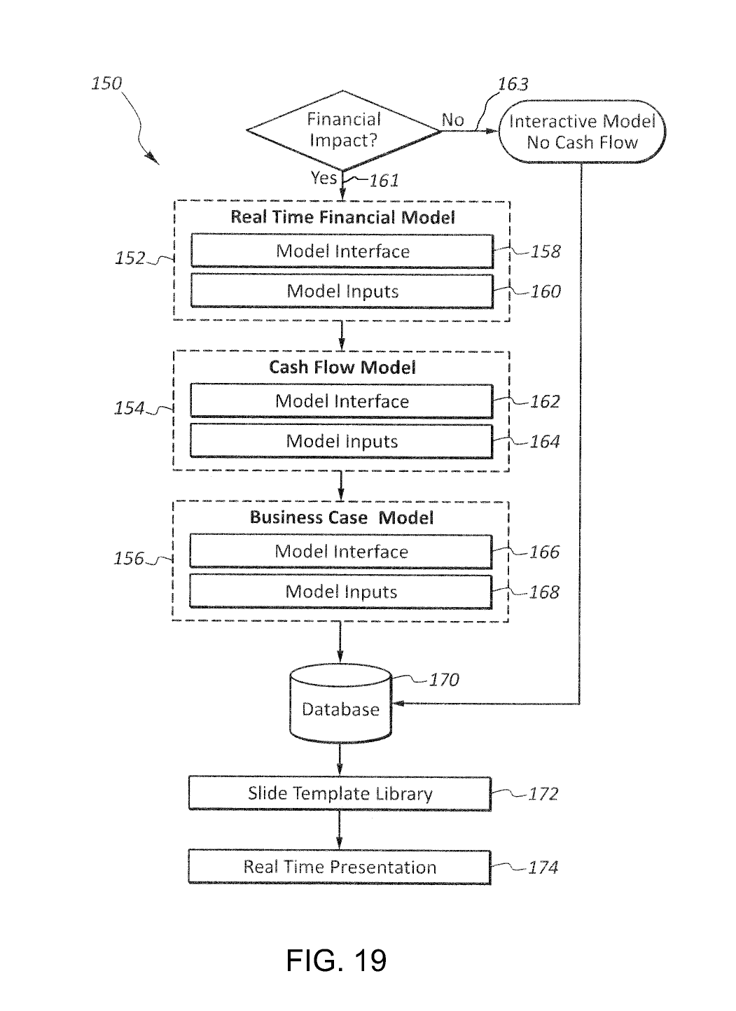

FIG. 19 depicts the architecture 150 of the model engine which develops a real-time financial model 152, a cash flow model 154 and a business case model 156. Initially, the user will need to select between a process in which there is a financial impact 161 and one where there is no financial impact 163. That is, the product could be one in which the financial impact is not involved. When it is, the real-time financial model 152 includes a model interface 158 that allows the user to manipulate data in real-time during a presentation. Thus the user may add, subtract, include and exclude as desired to suggest different results for different data and to present different or corrected results as data changes. Of course the system would necessarily need to have an input function 160 to accept data in whatever form and convert it for use in effecting the desired calculations for the real-time financial model.

The cash flow model 154 has a model interface 162 and model input function comparable to the real-time financial model. The cash flow model senses or reads changes in financial models in the real-time presentation. Any changes in the financial models are reflected in real-time in the cash flow model. The business case model 156 senses or reads changes in cash flow emanating from the cash flow model 154, which are then reflected in the business case model in real-time. The business case model 156 also has a model interface 166 and a model input 168.

The real-time model 152, the cash flow model 154 and the business case model 156 each are connected to a database 170 typically in parallel so that each model may directly access the data used by them. Each can be connected or disconnected by any suitable means (e.g., a key stroke) that allows the user to add or subtract models at will and in effect snap them in and out of the system so they are like or can be visualized to be comparable to building blocks.

In one alternative to the model library of FIG. 7, the model engine may include a model library 172 which houses all the various models of slides used in the system. Users can call up the models (in, for example, the user's workspace; see FIG. 18 and the disclosure relating thereto) using drag and drop technology. Thus, models can he dragged and dropped in a real-time presentation engine 174 to create a presentation. The real-time presentation engine 174 is connected to collect and present financial models in real-time with data being updated in real-time. It may receive live streaming video, live URL's and data from external data bases.

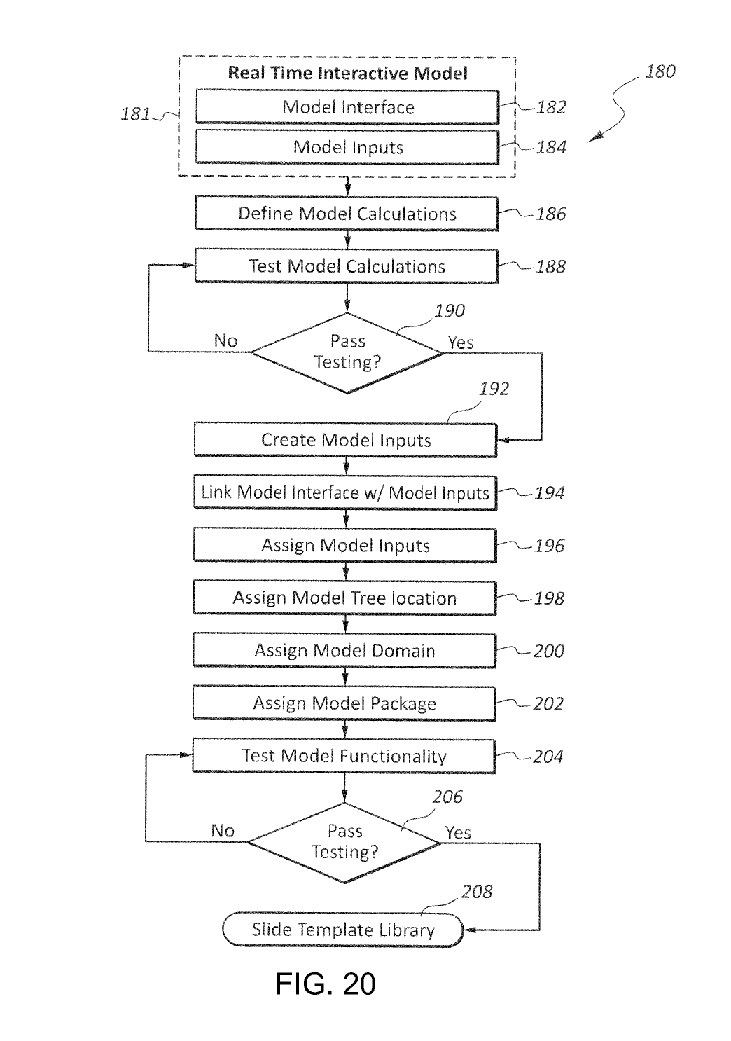

FIG. 20, a flow chart, shows how the model engine works within the overall system, as an alternative of the flow chart of FIG. 11, which describes one example how a model is built. FIG. 20 shows the steps taken by a model designer for a particular customer and/or product. The same steps will be taken for each model desired. Once the model is loaded into the library, it can be called up and used as a template for the user to insert data. The model is configured to conduct calculations automatically to present desired results in static or real time. The flow chart 180 shows as an example, development of the real-time interactive presentation 181 which is like or comparable to the real-time presentation 174 (FIG. 19) with a model interface 182 to receive data from the user, some well-known charting applications, or other suitable sources. The model input areas 184 arc connected to an underlying data base like data base 170.

The real-time interactive model 180 supplies data to a mathematical processing step 186. The model calculations have been developed and preloaded to calculate specific data like total sales or total units as discussed hereinafter. During model creation, the model designer tests the model calculations 188 to make sure it is presenting financial data and key metrics in real-time and to update with changing data. The model designer may test in different ways to make sure that the calculations that are preloaded into the model or slide are correct. For example the model designer may create a graph or chart to see if the data fits an expected result. If the test calculations 190 are satisfactory, then the model is next configured to accept model inputs 192.

For each interactive model, the model inputs 192 are linked to a model interface 194 that is much like model interface 182. The data is then assigned 196 to a model type such as the model it supports. Such a model may be a financial model, an animation model, and the like. If the data is sensed to be financial, then the model being designed will be configured so that the financial data will be accessible to other financial models and will appear in a tree 198 or location which in effect determines where it will appear within the system for access and use by users preparing a presentation for a customer. A model domain 200 has been created and is used to filter the data so that it will match or tit a template when the user is looking for or selecting a desired template. Thereafter, the various models that have been created are configured so they can be assigned to a client account 202 for access and use in connection with that account and the related presentation of findings when filled in. Data may be presented in a test model 204 to determine if it is logical or fits within guidelines. If the model passes testing 206, the model created is sent to storage as a template in a slide library 208. If it does not, it is sent back for redesign or correction until it meets or performs as desired.

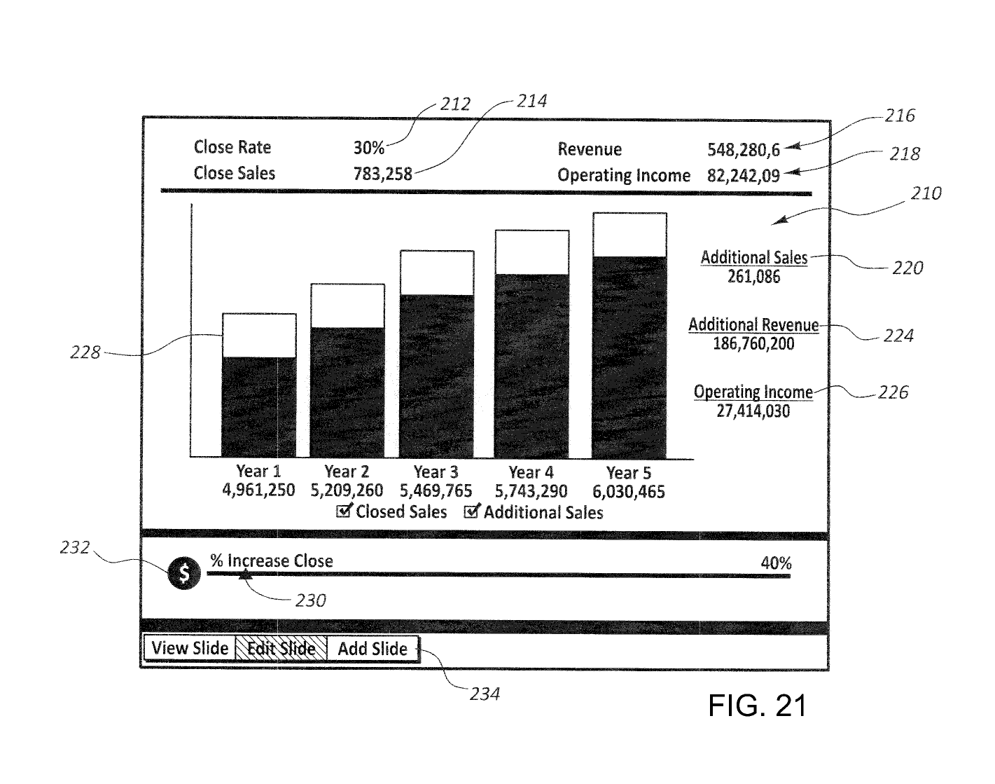

To better understand how the model engine discussed herein above operates, let us assume that a proposal is made for a telephone call processing center similar to that discussed hereinbefore. Operation of the system will produce a model display as seen in FIG. 21 showing an increase in close rate visually depicting the increase in cash flow 228 from the increasing close rate. The numbers shown are purely hypothetical and do not reflect any known business or system. The close rate impact area 210 of FIG. 21 is depicted as a model that is created using a suitable template and migrating and integrating data from the data base into it. Various calculations are preset to process and calculate various numbers including, for example, the close rate 212, close sales in units or calls, 214, close revenues in dollars 216, and operating income 218. The model is set to automatically calculate the additional sales 220 in units or calls, the additional revenue in dollars 224 and the total operating income 226 in dollars. To show differing metrics, an input data field, such as a slider 230, is available for use to, for example, vary the close rate. Alternately, an input data field may include a toggle switch 232 to separate data input boxes to vary the data and the results. A tool bar 234 is provided to allow the user to input data used in the calculations and provide other slide options.

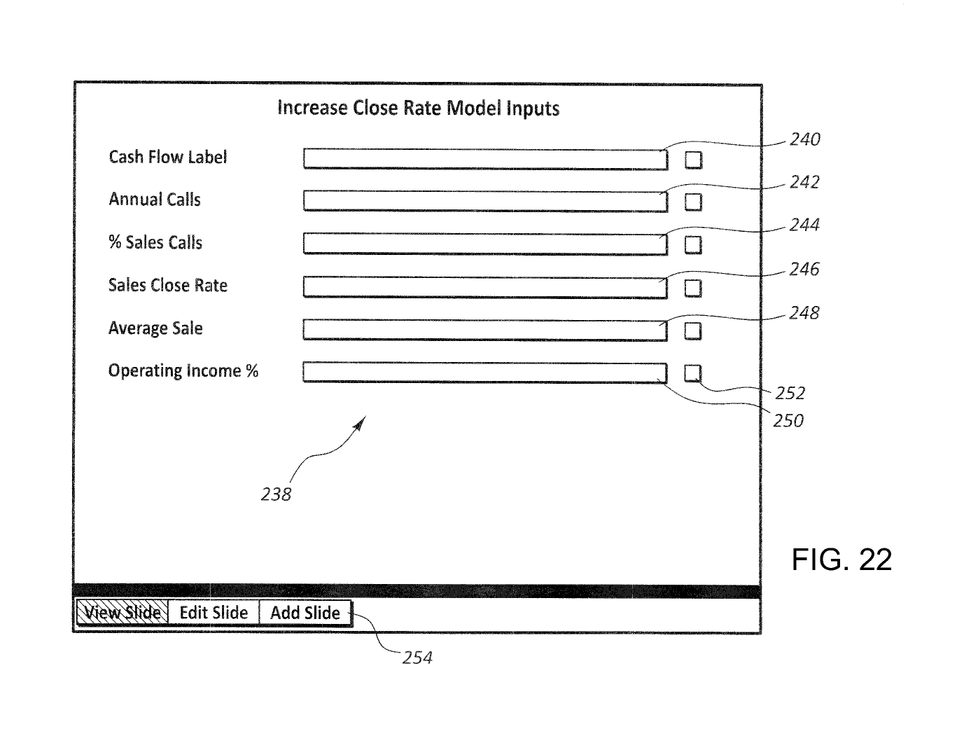

Data input areas 238 that are presented when one selects “edit slide” in the tool bar 234 are shown in FIG. 22 for the telephone call processing system discussed as an example. An input is provided to label the source of cash flow 240. Also provided are boxes tailored to this example to show total annual calls 242, percent of calls that are sales calls 244, close rate 246, average sale 248 and operating income 250. A separate field 250 is provided to allow a user to add notes like to identify the source of data. The user is able to vary the data as desired to show alternate results in FIG. 22. A tool bar 254 is provided to allow the user to edit the data but not the slide function itself.

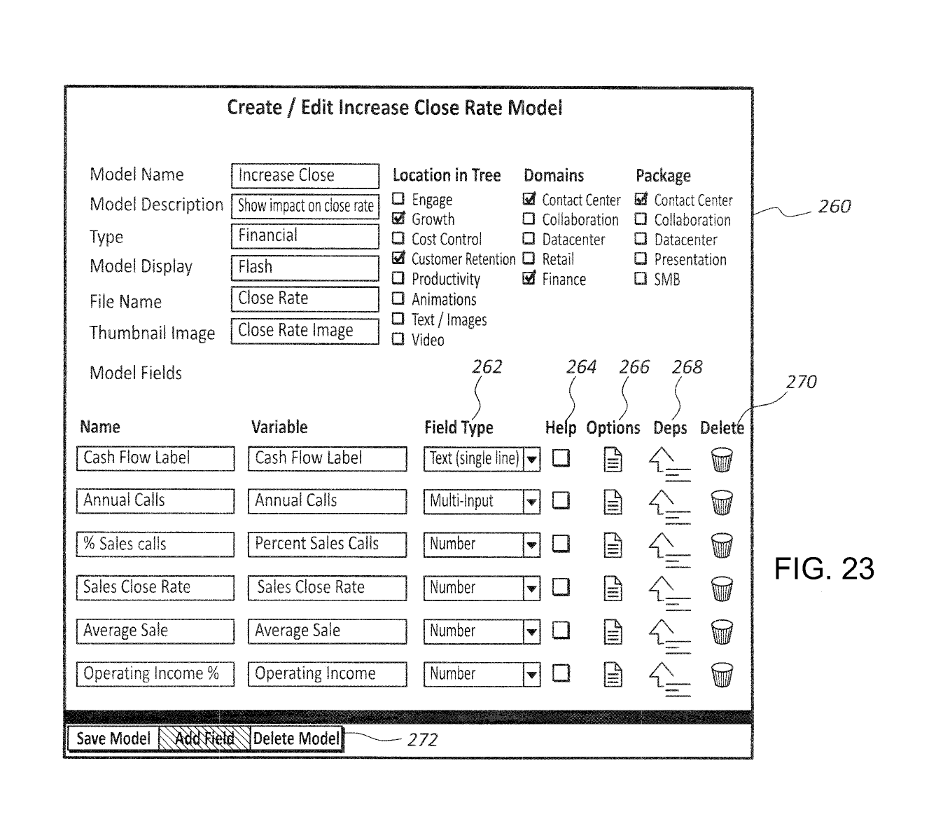

FIG. 23 is a system administration input screen used by the model designer in a model creator page 260 presented on a computer. That is, the present system has a computer configured to present a screen image with data fields to receive input data from the model creator, which connects the model interface with the model inputs and places the model in the slide template library. The data fields are labeled and are mostly self-evident for the telephone call processing system of the example. Other products would be configured to receive other data pertinent to that product. The data input fields for each model are fixed and to be of different types based upon the specifications of the model. In FIG. 23, the fields of data include a field type 262 which allows the model creator to input the type of variable field needed for the data. A “help” field 264 is provided to allow the user to access explanatory assistance and make the system user friendly. An “options” field 266 is a drop down list of options available to manipulate the data. A “dependents” field 268 is a field that is dependent when the edit slide 230 (FIG. 21) is selected and operated. The delete icon 270 allows the model creator to delete an entire field from the involved data base. A tool bar 272 is also available to the model creator to save, delete the model and add fields if they are available for this model.

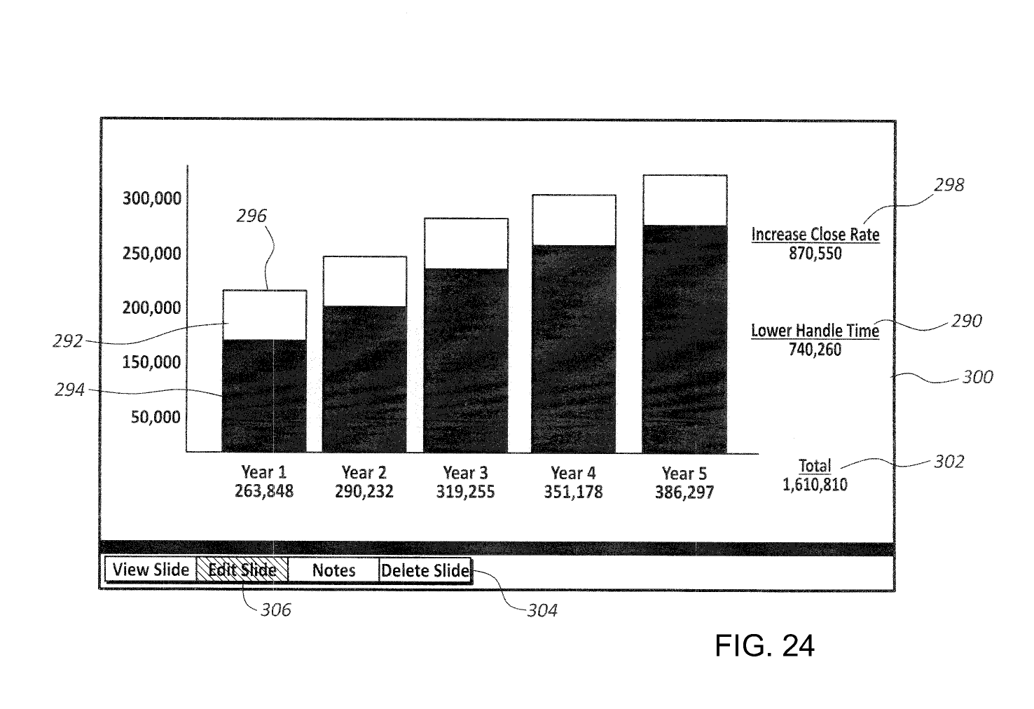

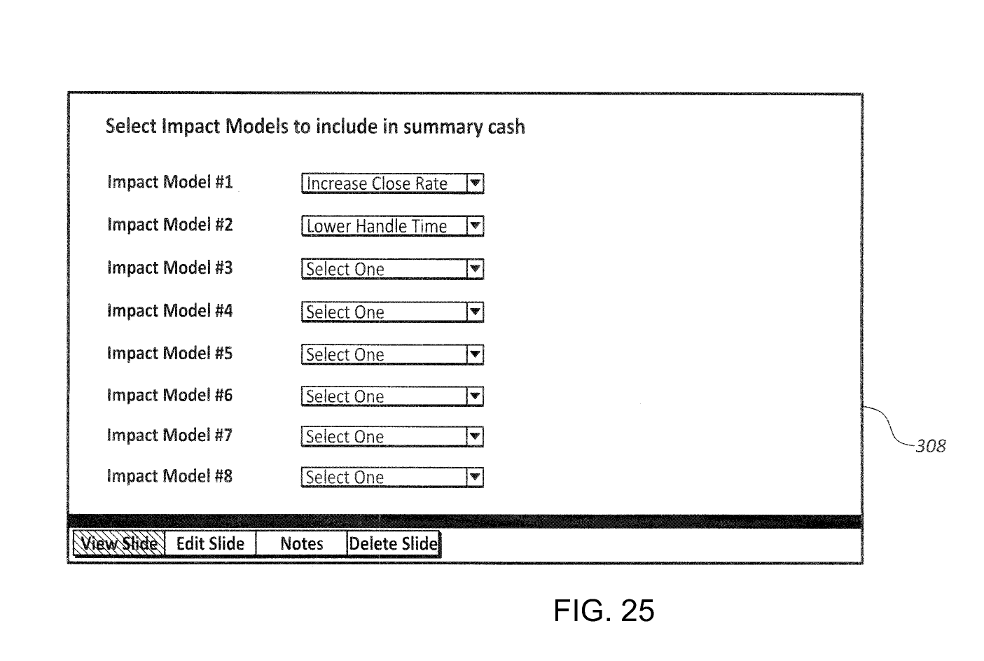

As earlier stated, the model engine translates each impact area into a single function that expresses benefits in terms of cash flow. Thus, a change in the rate of closing sales or shortening the time to complete a sale can translate into cash flow. FIG. 24 shows a cash flow model 300 that summarizes the cash flows from the Increase Close Rate financial impact model 292 and a lower handling time financial impact model 294 into one bar 296 for the example that involves a telephone call system. The total 302 is the total cash flow that was generated from the Increase Close Rate and Lower handle time financial models for the entire period is also shown. The total 302 is the total cash flow that was generated from the Increase Close Rate and Lower handle time financial models for the entire period is also shown. A tool bar 304 is provided that allows operations as seen. The edit slide button 306 when depressed causes a screen 308 to appear on the user's computer a sample of which for a telephone call system example as seen in FIG. 25. In effect, it allows the user to select the impact area models to be summarized in the cash flow model 300. The financial models are selected from the drop down list, and each financial model is added to the list as it is created.

To shorten the sales cycle for a “big ticket” product and in effect complete the sale faster, a credible business case must be presented. As earlier mentioned the financial factors of a good business case include the amount of the investment; the cash flow generated by the “big ticket” product; the net present value (NPV) created by making the investment; the total return by making the investment; the payback period; risk factors (e.g., a long payback period increases the risk of market change that could have a negative impact on the expected financial rewards projected at the outset); and an elasticity analysis. The role of the business case model is to capture the cash flows from the various cash flow models (for that presentation). A presentation may have multiple cash flow models that are used to summarize and visualize the business drivers for different areas of the customer's business. The business case model may roll up the different cash flow models to form the business case. Additionally, one presentation can include multiple business case models.

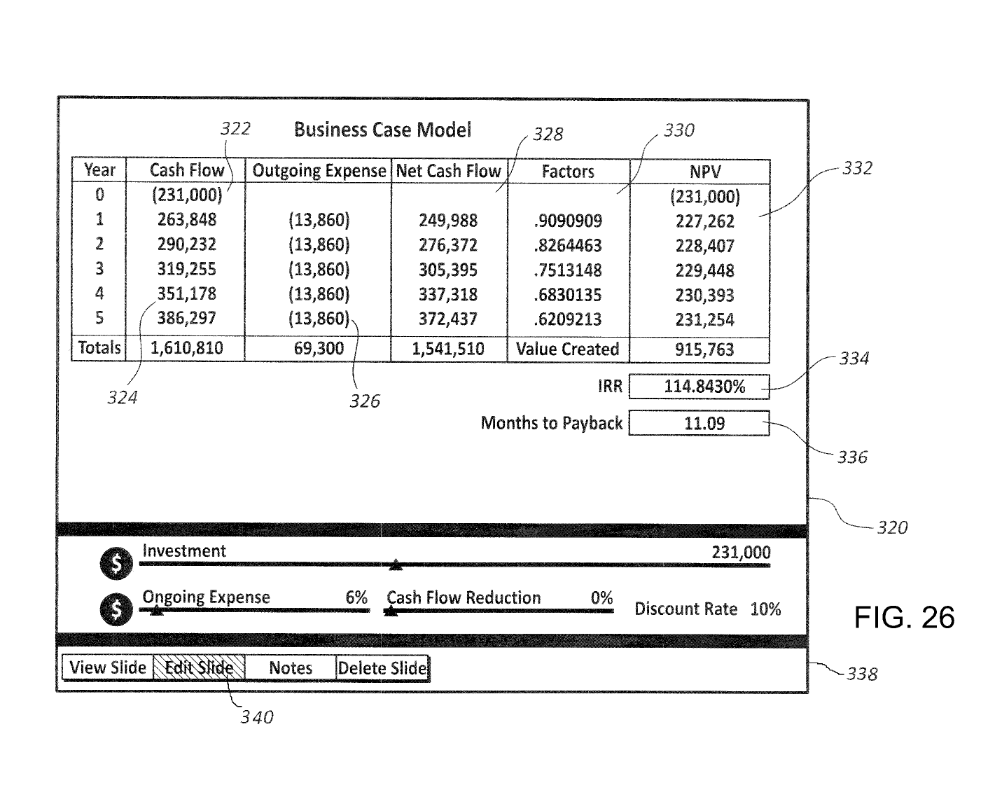

FIG. 26 is a business case model 320 for the theoretical telephone call processing system being discussed as an example. It shows the initial investment 322 along with the cash flow being developed 324. Ongoing expenses are seen 326 that are subtracted to create a net cash flow 328. The net present value (NPV) given the time period is calculated as follows:
NPV=ΣCF,
(1+r)¹
Where CF means cash flow
t means time from to 1 1
(4 years in example)
r means the discount rate

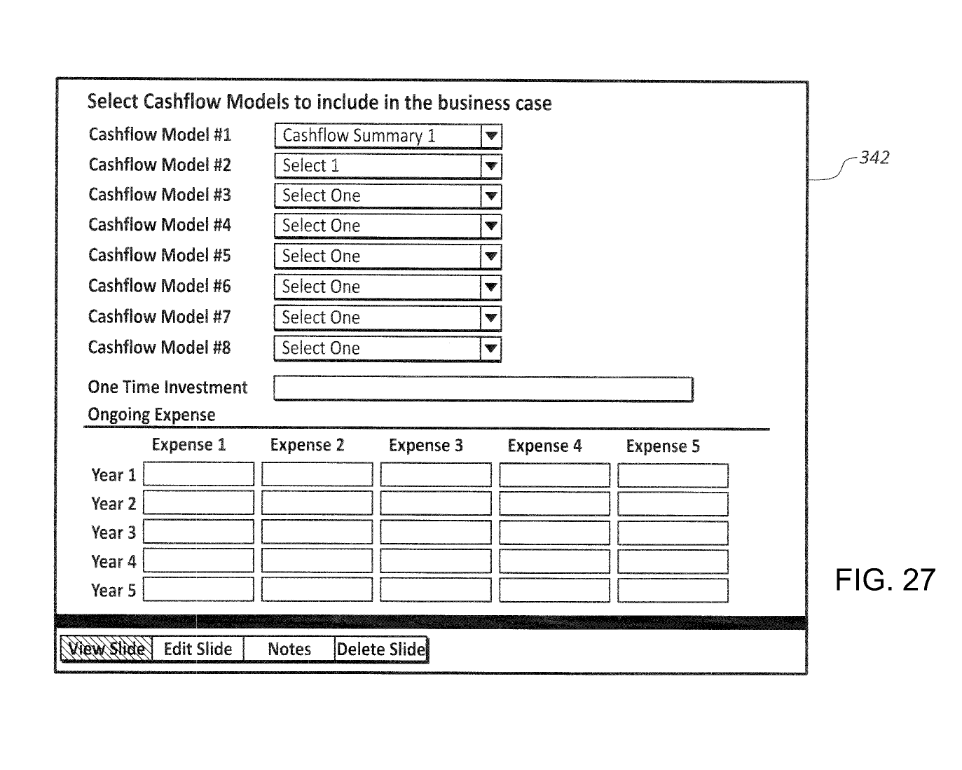

The NPV is applied to the Net Cash Flow 328 to yield the NPV of the cash flow, which translates cash flow received in the future into today's dollars. A calculation is also made to show the internal rate of return (IRR) 334 and the number of months for payback 334 which is the time it takes to recover the investment 322. The business case model of FIG. 26 also has a tool bar 338 which has a button to allow the user to effect certain actions. The edit button 340 causes a screen 342 (FIG. 27) to be presented on the user's computer to allow the user to select the cash flow models to include in the business case and input data such as the investment and/or ongoing expenses being observed in the business case model 320.

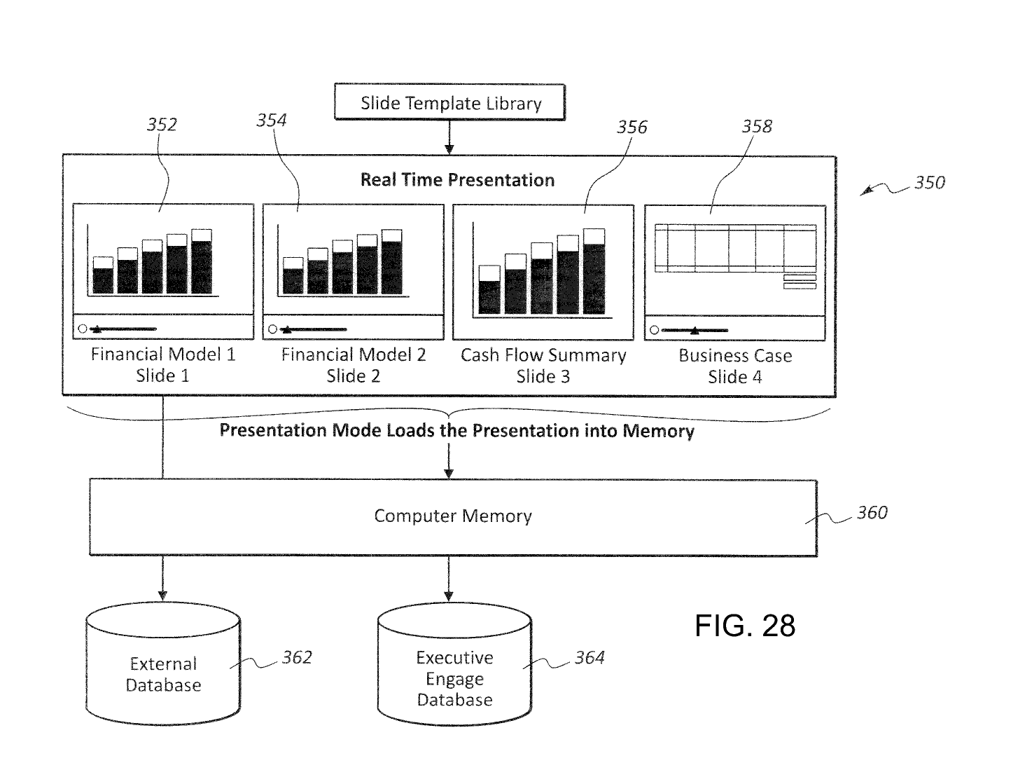

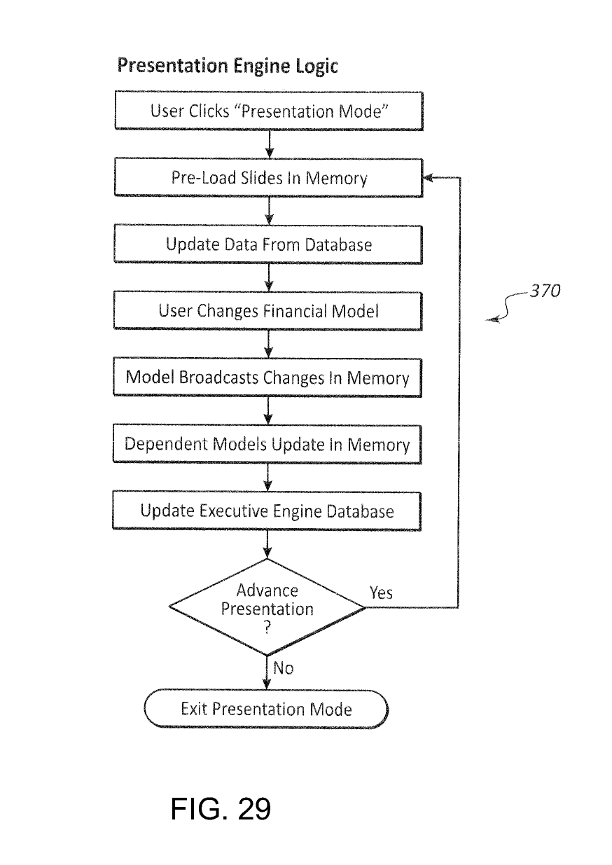

A real-time presentation engine has been created to present the information from the various models visually. FIG. 28 is a sample real-time presentation 350 for the telephone call system example that has been used herein to illustrate the overall system operation. Notably, the real-time presentation includes multiple screens or images that include financial models 352 and 354, cash flow model 356 and a business case 358. Obviously, the real-time presentation can include other models, images and summaries as desired by the user. The data is all accessible from the computer memory 360 and also from external databases 362 and 364 that may be needed for selected data. FIG. 29 is a flow diagram 370 showing the steps for the real-time presentation engine. The steps are labeled and in turn self-explanatory.

The above discussion should illustrate that the present disclosure is contemplated to be embodied in a system that involves “cloud” computing which is also known as Software as a Service (SaaS). So for example, the entire system being discussed may be hosted in Tier 4 datacenter. Users access the system via a Web Browser. Google Chrome is a preferred system, but the system herein disclosed will work with any modern browser. Once the cloud system is accessed, it can be seen that data is input by the user and that data is sent to the remote site where the computations are undertaken with the resulting data supplied back to the user.

In summary, the system herein disclosed delivers a systematic approach to delivering a business case. Accordingly, embodiments of the present disclosure provide for a programmatic approach to guided sales execution. Other embodiments of the disclosure provide the above advantage and further develops a system strategy based on business drivers and financial factors such that the benefits of the “big ticket” product or service are organized around business drivers and financial factors important to the customer and including ROI but separate from reliance on simple technological advances (it does it better/faster/cheaper). Still other embodiments of the present disclosure provide the above advantages and further provide for a system that facilitates collaborative collection of information related to a targeted company and building of a presentation touting the benefits of a product or service based on business drivers and financial factors to the targeted customer.

The approach is applicable for any type of sales that involves data collection, financial modeling, business case creation, and executive presentations.

In addition, the approach is applicable for sales directed to the offering of any product and/or service but more particularly to “big ticket” sales. For instance, the approach is applicable to the sale of any product or service in any technology or industry, such as electronics, automotive, software applications, raw materials, etc. More specifically, one programmatic approach is designed to be directed to a group of customers that all belong to the same technology or industry. As such, the overall approach is globally suited to that particular technology or industry, and furthermore can be tailored to a targeted customer within that group, such that implementation of the programmatic approach is directed to the targeted customer for purposes of sales execution.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A dynamic data modeling system for use in a real-time computerized presentation system, the dynamic data modeling system comprising:
a presentation engine having a visual interface displayable on a display screen of a computer, wherein the computer has a processor and a non-transitory memory;
a plurality of computerized numerical models stored in the non-transitory memory, wherein each of the plurality of computerized numerical models are importable into the presentation engine, wherein each of the plurality of computerized numerical models includes:
a data grid having a plurality of data cells, wherein the plurality of data cells are arranged into columns and rows, wherein numerical data values for use in the computerized numerical models are stored within at least a portion of the plurality of data cells;
at least one data input field controlling a manipulation of a first numerical data value in a first data cell using a mathematical function applied to a second numerical data value in a second data cell; and
a numerical model display displayed on the visual interface, wherein the numerical model display is based, at least in part, on the first numerical data value from the first data cell, wherein the numerical model display is changed in real-time based on the manipulation of the first numerical data value; and
a numerical model summary combining the numerical data from each of the plurality of computerized models imported into the presentation engine, wherein the numerical model summary is displayable on the visual interface.

2. The system of claim 1, wherein the visual interface is displayable simultaneously on at least two computerized display screens located remote from one another.

3. The system of claim 1, wherein the numerical model display further comprises at least one of a bar graph, a line graph, and a pie chart display of the numerical data value from the first data cell in the data grid.

4. The system of claim 1, wherein each of the plurality of computerized numerical models is importable into the presentation engine by dragging and dropping an icon representation of a computerized numerical model onto the visual interface of the presentation engine.

5. The system of claim 1, wherein the at least one data input field further comprises at least one of: textual data, an image, numerical data, a selectable list, radio buttons, check boxes, sliders, and tabs.

6. The system of claim 1, wherein the at least one data input field controls the manipulation of the first numerical data value in the first data cell using the mathematical function applied to the second numerical data value in the second data cell to create a third numerical data value positioned in a third cell.

7. The system of claim 1, wherein the at least one data input field of the computerized numerical models is located on the numerical model display, wherein the first numerical data value within the data grid is manipulated by a user with the at least one data input field while maintaining a view of the numerical model display.

8. The system of claim 1, wherein the mathematical function applied to the second numerical data value to manipulate the first numerical data value further comprises at least one of: addition, subtraction, division, and multiplication between the first and second data cells.

9. The system of claim 1, wherein the numerical model summary includes a graphical display having the combined numerical data from each of the plurality of computerized models imported into the presentation engine.

10. The system of claim 1, wherein a portion of numerical data values within the data grid of each of the plurality of computerized numerical models is shared between two or more of the computerized numerical models.

11. The system of claim 1, wherein the numerical model summary comprises:
a summary data grid having the combined numerical data from each of the plurality of computerized models imported into the presentation engine;
at least one summary data input field controlling a manipulation of the combined numerical data value into at least one of a plurality of data cells within the summary data grid; and
a graphical summary of the combined numerical data from each of the plurality of computerized models imported into the presentation engine.

12. The system of claim 1, wherein the at least one data input field is operable by a user from the visual interface of the presentation engine and is connected to any one of the plurality of data cells within the data grid to manipulate the numerical data value therein relative to at least one of:
a plurality of data cells within the data grid of a first computerized numerical model;
at least one data cell within the data grid of at least two different computerized numerical models; and
data retrieved from an external data source.

13. A method of modeling data for use in a real-time computerized presentation system, the method performed by a processor of a computerized device having a non-transitory memory, the method comprising:
importing a plurality of computerized numerical models stored on the non-transitory memory of the computerized device into a presentation engine, the presentation engine having a visual interface displayable on at least display screen of the computerized device, wherein each of the plurality of computerized numerical models has a data grid having a plurality data cells, wherein the plurality of data cells are arranged by columns and rows, wherein numerical data values are stored within at least a portion of the plurality of data cells;
using at least one data input field to manipulate at least a first numerical data value within at least a first data cell of the data grid using a mathematical function applied to at least a second numerical data value in a second data cell of the data grid;
visually displaying a numerical model display on the display screen of the computer before manipulating the first numerical data value and after manipulating the first numerical data value while maintaining visual display of the numerical model display, wherein the numerical model display is changed in real-time based on the manipulation of the first numerical data value;
combining the numerical data from each of the plurality of computerized models imported into the presentation engine; and
visually displaying a numerical model summary having the combined numerical data from each of the plurality of computerized models on the display screen of the computer.

14. The method of claim 13, wherein manipulating the first numerical data value with the at least one data input field further comprises adjusting at least one of: textual data, an image, numerical data, a selectable list, radio buttons, check boxes, slide bar, and tabs of the at least one data input field.

15. The method of claim 14, wherein at least one data input field is positioned proximate to the numerical model display, wherein both the at least one data input field and the numerical model display are viewable on the visual interface of the presentation engine.

16. The method of claim 13, wherein the at least one data input field controls the manipulation of the first numerical data value in the first data cell using the mathematical function applied to the second numerical data value in the second data cell to create a third numerical data value positioned in a third cell.

17. The method of claim 13, wherein the numerical model summary includes a graphical display having the combined numerical data from each of the plurality of computerized models imported into the presentation engine.

18. The method of claim 13, wherein a portion of numerical data values within the data grid of each of the plurality of computerized numerical models is shared between two or more of the computerized numerical models.

19. The method of claim 13, wherein the numerical model summary comprises:
a summary data grid having the combined numerical data from each of the plurality of computerized models imported into the presentation engine;
at least one summary data input field controlling a manipulation of the combined numerical data value into at least one of a plurality of data cells within the summary data grid; and
a graphical summary of the combined numerical data from each of the plurality of computerized models imported into the presentation engine.

20. A computer-implemented, dynamic data modeling system for use in a real-time computerized presentation system, the dynamic data modeling system comprising:
a presentation engine stored on a non-transitory memory of a computerized device having a processor and a display screen, wherein a visual interface of the presentation engine is displayable on the display screen, wherein the processor of the computerized device is configured to:
import a plurality of computerized numerical models stored in the non-transitory memory of the computerized device into the presentation engine, each of the plurality of computerized numerical models having a data grid with a plurality data cells, wherein the plurality of data cells are arranged into columns and rows, wherein numerical data values for use in the computerized numerical models are stored within at least a portion of the plurality of data cells;
provide at least one data input field to a user of the computerized device to control a manipulation of a first numerical data value in a first data cell using a mathematical function applied to a second numerical data value in a second data cell;
display a numerical model display on the visual interface of the presentation engine, wherein the numerical model display is based, at least in part, on the first numerical data value from the first data cell;
change the numerical model display in real-time based on the manipulation of the first numerical data value; and
combine the numerical data from each of the plurality of computerized models imported into the presentation engine into a numerical model summary, wherein the numerical model summary is displayable on the visual interface.
